(19) United States
(12) Patent Application Publication
(10) Pub. No.: US 2018/0201453 A1
(43) Pub. Date: Jul. 19, 2018

(54) VACUUM POWERED SELF-CONTROLLED LOADING AND CONVEYING GRANULAR MATERIAL

(71) Applicant: Stephen B. MAGUIRE, West Chester, PA (US)

(72) Inventor: Stephen B. MAGUIRE, West Chester, PA (US)

(21) Appl. No.: 15/918,161

(22) Filed: Mar. 12, 2018

Related U.S. Application Data
(63) Continuation-in-part of application No. 15/829,283, filed on Dec. 1, 2017.
Application No. 15/829,283 is a division of application No. 15/470,065, filed on Mar. 27, 2017.
Application No. 15/470,065 is a continuation-in-part of application No. 14/804,404, filed on Jul. 21, 2015.
Application No. 14/804,404 is a continuation-in-part of application No. 14/574,561, filed on Dec. 18, 2014, now Pat. No. 9,604,793.
Application No. 14/574,561 is a continuation-in-part of application No. 14/185,016, filed on Feb. 20, 2014, now Pat. No. 9,371,198.

(51) Int. Cl. B65G 53/66; B29C 31/02; B65G 53/26

(52) U.S. Cl. CPC B65G 53/66; B65G 53/26; B29C 31/02

(57) ABSTRACT

Method for pneumatically conveying granular material from a supply thereof through a conduit to a plurality of receivers for temporary storage of the material prior to molding or extrusion thereof by drawing vacuum in the conduit using a vacuum pump and controlling the vacuum pump in response to sensed vacuum level in the conduit.

### CROSS-REFERENCE TO RELATED PATENT APPLICATIONS

This patent application is a 35 USC 120 continuation-in-part of co-pending U.S. patent application Ser. No. 15/829,283, entitled “Flow Limiting and Variable Frequency Drive Apparatus for Limiting Flow to Selected Level” filed 1 Dec. 2017 in the names of James Zinski and Stephen B. Maguire.

This patent application is also a 35 USC 120 division of co-pending U.S. patent application Ser. No. 15/470,065 entitled “Self-Controlled Vacuum Powered Granular Material Conveying and Loading System and Method”, filed 27 Mar. 2017 in the name of Stephen B. Maguire.

The '065 patent application was a 35 USC 120 continuation-in-part and of U.S. patent application Ser. No. 14/804,404 entitled “Vacuum Powered Resin Loading System Without Central Control” filed 21 Jul. 2015 in the name of Stephen B. Maguire.

The '065 patent application was further a 35 USC 120 continuation-in-part of U.S. patent application Ser. No. 14/574,561 entitled “Resin Delivery System with Air Flow Regulator” filed 18 Dec. 2014, issued as U.S. Pat. No. 9,604,793 on 28 Mar. 2017. The '561 application claimed the priority of and was a continuation-in-part of U.S. patent application Ser. No. 14/185,016, issued as U.S. Pat. No. 9,371,198 on 21 Jun. 2016, entitled “Air Flow Regulator”.

The priority of the '283 application, the '065 application and the priority of all the patent properties from which the '065 application claimed priority, directly or indirectly, is claimed under 35 USC 120.

### STATEMENT REGARDING FEDERAL FUNDING FOR THIS INVENTION AND TECHNOLOGY

Not applicable.

### INCORPORATION BY REFERENCE

This patent application incorporates by reference the disclosures of U.S. Pat. Nos. 6,089,794; 8,753,432; 9,387,996; 9,394,119; 9,550,635; 9,550,636; and 9,604,793. This patent application further incorporates by reference the disclosures of U.S. patent publications 2016/0297625 A1; 2016/0185538 A1; 2016/0214793 A1; 2016/0185537 A1; and 2016/0244275 A1.

### BACKGROUND OF THE INVENTION

This invention relates to manufacture of moldable and extrudable articles and more particularly relates to pneumatic conveyance and processing of plastic resin pellets and other granular materials prior to molding or extrusion of those pellets or other materials into a finished or semi-finished plastic product.

### Description of the Prior Art

In facilities that fabricate plastic and other material products by molding or extrusion, it is common to use “vacuum systems” to pneumatically convey pellets of thermoplastic resin or granules of other material, prior to molding or extrusion of those pellets or granules into a finished or semi-finished product, from a central storage point to each of the many compression or injection plastic molding machines or plastic extruders scattered throughout the facility. Individual loaders, which are referred to as “integral” loaders because they contain their own vacuum motor and generate their own vacuum, can be used for conveying plastic resin pellets or other material granules short distances, typically 20 feet or less. When the plastic resin pellets or other material granules are purchased in 50 pound bags, 200 pound drums, or 1,000 pound containers commonly referred to as “Gaylords”, these bags, drums, and/or containers can be placed close to the molding press or extruder and small integral loaders can be used to convey the plastic resin pellets or other material granules from the storage bag, drum, or container to the molding press or extruder.

In this patent application, injection and compression molding presses and extruders are collectively referred to as “process machines.”

Another approach for conveying plastic resin pellets or other material granules from a storage location to a process machine, which approach is often used in larger facilities, is to install a central vacuum pump or even several vacuum pumps, connected by one or more common vacuum lines to multiple “receivers.” Receivers are loaders which lack integral power units. A receiver is shown in U.S. Pat. No. 6,089,794. Receivers are used for temporary storage of granular resin material, specifically plastic resin pellets, before those plastic resin pellets are demanded and forwarded to a process machine such as an injection molding machine or an extruder.

Vacuum pumps connected to the vacuum lines draw vacuum, namely air at pressure below atmospheric, as the vacuum pump sucks air through the “vacuum” line. The suction moves large quantities of air at significant velocity, carrying pellets, or other granules of thermoplastic resin, or other materials through the “vacuum” line. An alternative is to use positive pressure produced by a blower or the exhaust side of a vacuum pump. Either approach results in a movement of substantial amounts of air which may be used to carry plastic resin pellets or other material granules.

In practice, vacuum pumps are preferred and vacuum lines are desirable in part because power requirements to create the required vacuum necessary to carry plastic resin pellets or other material granules through the lines are lower than the power requirements if the plastic resin pellets or other material granules are pushed through the lines by a blower or the exhaust side of a vacuum pump. When vacuum is used, the static pressure within the line may be not much less than atmospheric; when positive pressure is used, the dynamic pressure of the air flowing through the line must be relatively high in order to move adequate amounts of plastic resin pellets or other material granules.

“Receiver-based” central loading systems for granular resin or other granular materials typically have one vacuum pump connected to many receivers. When a receiver calls for material, the pump starts, and that single receiver is loaded. Loading is done one receiver at a time.

If several receivers call for material simultaneously, too much air is drawn into the system and the conveying vacuum drops to the point of not conveying correctly.

Some receiver-based systems use larger diameter vacuum lines as vacuum reservoirs. In such a case, the vacuum pump keeps running to hold a high vacuum level in the large capacity vacuum line network. In that case, when a receiver calls for material, the required vacuum is available. Also, several receivers can call for material at the same time as a large reserve of vacuum is available. However, if too many receivers come on line at the same time, then the vacuum level will drop too much, i.e. becomes too close to atmospheric. Or if one of the receivers is not pulling material, and just air, the resulting greatly increased volume of air is a problem.

As used herein, and in light of the foregoing explanation, the terms “vacuum pump” and “blower” are used interchangeably and are synonymous.

When one or more central vacuum pumps are connected to multiple receivers, a receiver is located over each temporary storage hopper, in which the plastic resin pellets or other material granules are temporarily stored immediately before being molded or extruded, and a temporary storage hopper is associated with each process machine. Receivers feed the temporary storage hopper associated with each process machine; each such process machine has a temporary storage hopper, conventionally referred to as the “hopper” which is generally mounted on the machine and is the final repository for any plastic resin pellets before being fed to the screw of the injection molding machine or extruder.

In prior art systems, each receiver is connected by a control wire to a central control system. The control system works by selectively opening a vacuum valve in each receiver, allowing one or several vacuum pumps to sequence draw “vacuum”, i.e. below atmospheric pressure air, to carry the pellets or other granules among and to multiple receivers as individual ones of the receivers, positioned over individual hoppers associated with the individual process machines, require additional plastic resin pellets or other material granules. The receiver for a given hopper-process machine combination is actuated by opening the vacuum valve located in or near the receiver, causing the receiver to feed plastic resin pellets or other material granules by gravity into the hopper from where the pellets or other granules may be fed by gravity downward into the associated process machine.

Large, high capacity industrial vacuum pumps are reliable and are suited to heavy duty industrial use. Use of large high capacity vacuum pumps allows long conveying distances for the plastic resin pellets or other granular material. Currently available large capacity vacuum pumps permit plastic resin pellets or other granular material to be conveyed over distances of 200 feet or more using vacuum drawn by the pump. Actuating such high capacity vacuum pumps results in a big rush of below atmospheric pressure air through the line, carrying the plastic resin pellets or other material granules over a long distance.

Operators of plastic manufacturing facilities prefer to buy plastic resin pellets or other material in bulk, in rail cars or tanker trucks. Bulk purchases result in cost savings. Plastic resin pellets or other material granules delivered in bulk are typically pumped into large silos for storage. In a large manufacturing facility, the distance from a plastic resin pellet or other material granules storage silo to a process machine may be several hundred feet, or more. Accordingly, when plastic resin pellets or other material granules are purchased in bulk, a central vacuum-powered conveying system, powered by one or more large, high capacity industrial vacuum pumps, is a necessity.

Typically, large central vacuum-powered plastic resin pellet or other material granule conveying systems have one or more vacuum pumps, each typically from 5 to 20 horsepower. These central vacuum-powered systems include a central control connected by wire to each receiver associated with each process machine in the facility. Typically eight, sixteen, thirty-two or sixty-four receivers, each associated with a process machine, may be connected to and served by the central plastic resin pellet or other granule material vacuum conveying system. Of course, the higher the number of receivers served by the system, the higher the cost.

A factor to be considered in designing such a system is the speed of the plastic resin pellets or other material granules as they flow through a conduit as the plastic resin pellets are carried by the moving air stream drawn by the vacuum pump.

If air flow is too slow, the plastic resin pellets or other material granules fall out of the air stream, lie on the bottom of the conduit, and there is risk of clogging the conduit.

If air flow is too fast, the plastic resin pellets or other material granules can skid along the conduit surface. In such case, harder, more brittle plastic resin pellets or other material granules may be damaged, resulting in dust within the conduit, which when drawn into the vacuum pump can damage the vacuum pump and render the system inoperative. Softer plastic resin pellets or other material granules heat up and can melt from friction resulting from contact with the conduit interior surface. This results in “angel hair”—namely long, wispy-thin strands of plastic film which eventually clog the conduit and cause the system to shut down.

For these reasons, pneumatic plastic resin pellet or other granule material conveying systems must be designed to produce desired, reasonable conveying speeds for the plastic resin pellets or other material granules.

Conveying speed of the plastic resin pellets or other material granules is most often controlled by controlling air flow, measured in cubic feet per minute, and varying the desired and designed cubic feet per minute based on conduit diameter, with a relatively larger diameter conduit requiring relatively more cubic feet per minute of air flow to maintain proper air flow speed through the conduit. Controlling air flow, measured in cubic feet per minute, is done by properly specifying the vacuum pump by capacity and, in some cases, by varying speed of the vacuum pump as the vacuum pump draws the air in a “vacuum” condition through the conduit, carrying plastic resin pellets or other material granules in the moving below atmospheric pressure air. Controlling cubic feet per minute of air flow is an indirect way of controlling plastic resin pellet or other granule material speed as the plastic resin pellets flow through a conduit of a given diameter.

Typically, a 2 inch diameter conduit requires about 60 cubic feet per minute of air flow for typical plastic resin pellets or other material granules. A 2½ inch diameter conduit typically requires 100 cubic feet per minute of air flow for typical plastic resin pellets or other material granules. To achieve these desired air flow volumes, the designer must carefully match the horsepower of a vacuum pump, which has a given cubic feet of air per minute rating, to a selected size conduit, taking into consideration the average distance the plastic resin pellets or other material granules must be conveyed through the conduit from a storage silo to a receiver or loader. If this results in selection of a 5 horsepower blower/vacuum pump, then a given facility may require several such blowers/vacuum pumps, with each blower/vacuum pump supplying only a selected number of receivers.

A single plastic resin or other granular material molding or extruding facility might theoretically require a 20 horsepower vacuum pump and the corresponding cubic feet per minute capability for the conveyance provided by the vacuum pump to meet the total conveying requirements for plastic resin pellets or other material granules throughout the facility. However, a single 20 horsepower vacuum pump would result in far too high a conveying speed for the plastic resin pellets or other material granules through any reasonable size conduit. As a result, the conveying system for the plastic resin pellets or other material granules in a large facility is necessarily divided and powered by 3 or 4 smaller vacuum pump, resulting in 3 or 4 different, separate systems for conveyance of plastic resin pellets or other material granules. Sometimes several vacuum pump are connected to a single set of receivers, with one or more of the extra vacuum pump turning “on” only when required to furnish the required extra cubic feet per minute of air flow. This is controlled by a central station monitoring all receivers and all vacuum pump, with the central station being programmed to maintain all of the hoppers associated with the process machines in a full condition, wherever those hoppers are located throughout the facility.

Even with careful planning and design, results achieved by such pneumatic plastic resin pellet or other granular material conveying systems are not consistent. Air flow speed and cubic feet per minute capacity of blowers often vary and are outside of selected design and specification values.

### DESCRIPTIVE SUMMARY OF THE INVENTION

This invention provides an improvement to known pneumatic plastic resin pellet or other granular material conveying systems, reducing the costs of those systems while providing more consistent control of air speed and delivered cubic feet per minute of air for individual receivers. The invention facilitates easy expansion of the pneumatic plastic resin pellet or other granular material conveying system as the system grows. Such expandable systems are made feasible in part by the air flow limiter disclosed herein, which is also disclosed and claimed in pending U.S. patent application Ser. No. 14/185,016 such expandable systems are in part also made possible by the novel receiver disclosed and claimed in this application.

In another one of its inventive aspects, this invention provides a receiver for use in a pneumatic granular resin or other granular material delivery system for receiving and temporarily holding granular resin material or other material granules until needed by a process machine. The receiver includes a vessel having an input port for receipt of pneumatically conveyed granular resin material or other material granules, an outlet port for discharge of the granular resin material or other material granules held in the vessel, and a second outlet port for escape of pneumatic conveying air. The receiver preferably further includes a sensor for detecting level of granular resin material or other material granules in the vessel, and opening the input port for receipt of granular resin material or other material granules when the detected level of granular resin material or other material granules is low. The receiver preferably further includes a second sensor for detecting level of vacuum in a pneumatic resin or other granular material conveyance conduit connected to the inlet port and closing the inlet port when vacuum level in the conduit is below a preselected level.

The air flow limiter that is the subject of U.S. Pat. No. 9,371,198, prevents excessive air from entering a resin or other granular material conveying vacuum based system.

Many large central systems often have too much capacity and result in conveying material at too great a velocity. The flow limiter that is the subject of the '198 application also eliminates that issue as flow in cubic feet per minute (CFM) is held to design levels.

With these flow limiters in place at each receiver, or at least at most of the receivers, and in any event at critical pre-calculated positions in the system, new design approaches are feasible.

Use of air flow limiters make it much more likely that multiple receivers can load successfully at the same time.

If a conventional receiver is pulling resin material or other granular material from a container that has run dry of material, and the receiver now is just sucking air due to controller operation of the blower, this is not so damaging to a central vacuum powered system when the receiver has an air flow limiter associated with it.

With use of air flow limiters as disclosed herein and the receivers as disclosed and claimed in this patent application, the central control system, which heretofore has been used to tell each receiver when it can load, can be eliminated.

In another one of its inventive aspects, this invention provides a variable speed drive for the vacuum pump in a granular resin or other granular material pneumatic delivery system. Use of a variable speed drive on the vacuum pump, together with self-regulating receivers of the type disclosed herein, and air flow limiters of the type disclosed herein, allow the fabrication and operation of vacuum powered resin loading systems without any central control, thereby substantially reducing costs and increasing reliability of pneumatically-powered granular plastic resin or other granular material delivery systems.

With the flow limiter as described in the '198 patent and herein, the vacuum pump(s) can be controlled to hold a certain level of vacuum. Using a variable frequency drive control to vary vacuum pump speed, one can speed up or slow down the vacuum pump as required, based on a vacuum level reading at or near the vacuum pump.

At each of the new receivers the opening of a vacuum valve connection to the main vacuum reservoir line is based on two criteria: The usual and heretofore only criteria is when a low material level is detected, and there is a consequent need to load. The second criteria, namely that the vacuum level is high enough to convey, as sensed by the individual receiver, may also be used. This second criteria prevents too many receivers from coming on line at the same time, which previously has been a problem.

This system requires no central control. No network of wiring is required throughout the plant. Vacuum pump level is held to a correct level to meet vacuum loading requirements; multiple receivers can load at the same time.

By adding a flow limiter to every receiver or at least to most of the receivers, and in any event at critical positions in the system, plant operators can limit air flow in cubic feet per minute to a value that is ideal for the particular receiver, considering conduit diameter and distance over which the plastic resin pellets or other material granules must be conveyed. If such flow limiters are combined with receivers of the type disclosed and claimed herein, plant operators can be eliminated since the system is self-regulating and no central control is required.

In one of its many aspects, this invention provides a self-regulating vacuum powered system for delivery of granular plastic resin material or other granular material to a plurality of plastic resin material or other granular material processing machines. In this aspect, this invention includes a plurality of receivers, a plurality of air flow limiters, with at least some of the air flow limiters being operatively associated with a receiver. A vacuum pump draws granular resin material or other material granules through a conveying conduit under vacuum. The conveying conduit is connected to a supply of granular resin material or other material granules, to the air flow limiters, and to the receivers. Most desirably, an air flow limiter is associated with each receiver.

Further desirably, a variable speed drive is connected to the vacuum pump to allow variation of the vacuum pump speed according to selected parameters.

This aspect of the invention preferably further includes a plurality of vacuum level detectors each connected to a receiver for detecting vacuum level in the conveying conduit immediately upstream of a connected receiver.

In yet another of its aspects, this invention provides vacuum powered apparatus for delivery of granular plastic resin material or other material granules to a plurality of plastic resin material or other granular material processing machines, where the apparatus includes a resin conveying conduit, a plurality of receivers, a plurality of air flow limiters, with each of the air flow limiters preferably being connected to the conduit downstream of an associated receiver, with each of the receivers preferably being connected to an associated air flow limiter, and with the apparatus preferably further including a vacuum pump for drawing granular resin material or other material granules through the conveying conduit under vacuum, where the conveying conduit is preferably connected to a supply of granular resin material or other material granules, to the receivers and to the air flow limiters.

In still yet another one of its aspects, this invention provides vacuum powered apparatus for delivery of granular plastic resin material or other material granules to a plurality of plastic resin material of other granular material processing machines where the apparatus includes a first resin conveying conduit, a plurality of receivers connected to the first resin or other granular material conveying conduit, a plurality of air flow limiters, with each of the air flow limiters being connected to an associated receiver which is upstream thereof. The apparatus preferably yet further includes a second resin or other granular material conveying conduit of a size different from the first resin or other granular material conveying conduit. The apparatus preferably yet further includes a plurality of receivers connected to the second resin or other granular material conveying conduit and a plurality of air flow limiters, each of the air flow limiters being connected to an associated receiver downstream thereof, and further being connected to the second conveying conduit. A vacuum pump is connected to the first and second resin or other granular material conveying conduits.

In still yet another one of its aspects, this invention provides a receiver for use in a pneumatic granular resin or other granular material delivery system. The receiver serves to receive and temporarily hold granular resin material or other material granules until needed by a process machine. The receiver preferably includes a vessel having an input port for receipt of pneumatically conveyed granular resin material or other material granules, an outlet port for discharge of granular resin material held in the vessel, and an outlet port for escape of the conveying air. The receiver further preferably includes a sensor for detecting level of granular resin material or other material granules in the vessel and opening the input port for receipt of granular resin material or other material granules when detected level of granular resin material or other material granules in the vessel is low. The receiver preferably yet further includes a sensor for detecting level of vacuum in a pneumatic resin or other granular material conveyance conduit connected to the input port and overriding the opening of the input port when the vacuum level in the pneumatic resin or other granular material conveyance conduit less than a pre-selected level for adequate conveying.

In still another one of its aspects, this invention provides a method for pneumatically conveying granular resin material or other material granules from a supply thereof through a conduit to a plurality of receivers for temporary storage of the resin material or other granular material prior to molding or extrusion thereof, where the conveying is preferably effectuated by drawing vacuum into conduit by operation of a vacuum pump. In this method, the invention comprises the improvement of varying the vacuum pump speed in response to sensed vacuum level in the conduit proximate to the pump.

In yet another one of its aspects, the invention provides a method for pneumatically conveying granular resin material or other granular material from a supply thereof through a conduit to a plurality of receivers for temporary storage of the resin material or other material granules prior to molding or extrusion, where pneumatic conveyance is performed by drawing vacuum in the conduit by operation of the vacuum pump. In this method, an inventive improvement comprises limiting air flow downstream of a receiver to a maximum value to be drawn by the vacuum pump and varying the vacuum pump speed in response to sensed vacuum level in the conduit preferably at a position downstream of the location where air flow is being limited.

Use of air flow limiters and receivers in accordance with this invention allows pneumatic plastic resin pellet or other granular material conveying systems to utilize a single large high horsepower vacuum pump. In accordance with the invention, each receiver in a facility is preferably fitted with a flow limiter so the flow for each receiver in cubic feet per minute is self-limiting. The invention eliminates the need to size vacuum pumps or blowers to a specific material conduit size or conveyance distance. The flow limiter, together with the disclosed receiver, permits operators to run a very large vacuum pump or blower at a speed that will maintain a desired high level of vacuum throughout the entire vacuum (or pneumatic) material conveying system.

Using larger than standard diameter vacuum conduits allows a significant vacuum reserve to exist in the plastic resin pellet or other granular material conveying system, without the need for a vacuum reserve tank. Larger diameter conduits also mean there is little loss of vacuum over long conveying distances, even at the most distant receiver to which plastic resin pellets or other material granules are supplied by the system. A variable frequency drive control varies the speed of the preferably single large high horsepower vacuum pump to hold vacuum within a desired range. This saves energy when demand is low and vacuum is at the high end of a desired range. In this aspect of the invention at least one vacuum sensor provides input to control a variable frequency drive, varying the speed of the vacuum pump or blower.

With the flow limiter facilitating use of high horsepower vacuum pumps or blowers, designers utilizing the invention can now design to load multiple receivers at the same time without fear of dropping pressure or vacuum levels too low in portions of the respective pneumatic or vacuum material conveying system.

In the plastic resin pellet or other granular material conveying system aspect of the invention, no central control system is required. With the flow limiter(s), each receiver controls its own operation and is not wired to any central control facility. When the level of plastic resin pellets or other material granules in a particular receiver associated with a specific process machine falls to a sufficiently low level, the receiver level sensor tells the receiver to load. Operatively connected to the receiver level sensor is a receiver vacuum supply sensor, which confirms that sufficient vacuum is available to load the receiver. If too many other receivers are currently loading, and the sensed vacuum level for that particular receiver is below the threshold for effective loading, the receiver will wait until the vacuum level rises. When available system vacuum is sufficient to assure adequate flow of plastic resin pellets or other material granules into that receiver, the vacuum sensor causes the receiver vacuum valve to open, connecting the receiver to the conduit carrying the plastic resin pellets or other material granules, and the receiver loads.

In accordance with one aspect of the invention, each receiver acts on its own information. Use of the high horsepower vacuum pump means that multiple receivers can load simultaneously. Because no central control computer system is required, the cost of a central control system and the cost of running control wires, or providing wireless control such as Bluetooth or via the Internet, throughout a plastic facility are eliminated.

The flow limiter makes such systems in accordance with the invention possible. By limiting cubic feet per minute of flow that is required, there is no limit on the horsepower of the control pump. The risk of a too high a conveyance speed of the plastic resin pellets or other material granules through the conduit is eliminated.

In a conventional system, if the main supply of plastic resin pellets or other material granules becomes essentially exhausted, the empty conduit of the conveying system conveys a substantial amount of air, which drops the vacuum reserve of the entire conveying system very rapidly. But with invention having the flow limiter(s) together with receivers of the type disclosed and claimed herein present in the system, the risk of such dumping of air into the conveying conduit is substantially reduced, if not eliminated. Further contributing to minimized air dump into the vacuum conduit is the receiver's ability to detect vacuum pump failure or absence of material to be loaded, thereby stopping further load cycles and sounding an alarm.

In the preferred air flow limiter, the limiter has but a single moving part, a valve, which relies on two opposing forces, namely gravity in one direction and lift created by air flow in the opposite direction. Because the preferred air flow limiter uses gravity, air flow therethrough must be upward, essentially vertically through the air flow limiter, to counter the downward force of gravity.

The air flow limiter is desirably in the form of a tube with an air flow actuated valve within the tube. In a “no flow” condition, gravity holds the valve closed. However, as air flow through the limiter reaches a pre-selected design value, flow of air over and against a sail-like plate lifts an internal free floating valve, which shuts off air flow through the air flow limiter if the free floating valve rises sufficiently to contact a stop located within the tube.

By adjusting the size and/or shape of the “sail”, and the weight of the free floating valve, desired air flow can be regulated very closely. Gravity as a force in one direction means the opening force is constant over the full range of motion of the valve device. (A spring, if one were used, would provide a variable force. However, use of gravity in the preferred flow limiter eliminates that variable).

In the preferred flow limiter, at the desired design cubic feet per minute of air flow, the valve opens as it lifts. The valve would continue moving upwards except for the fact that the valve reaches a point of air flow restriction, where the valve holds air flow steady at the desired design value. If the valve moves further upwardly towards a “closed” position, this reduces air flow, causing the valve to drop. If the valve drops below the control level, this allows more air flow and consequently the valve rises. As a result, the valve reaches the desired design equilibrium control point essentially instantly and accurately.

Known air flow shutoffs are subject to “vacuum pull”, causing them to shut off completely once air begins to flow. This is because in known shutoffs, vacuum pull of the vacuum pump is always present. However in the preferred flow limiter as disclosed herein, a short vertical tube closes against a flat horizontal surface. In this preferred flow limiter, air flow is directed through the center of the short tube and escapes over the top edge of the short tube and then around open edges of a flat shutoff surface. A flat, desirably triangular or star-shaped plate is positioned in the air flow below and connected to the short tube. This plate acts as the “sail” in the air flow and will, at the designed desired cubic feet per minute air flow rate, provide enough lift to raise the short tube against the shutoff plate.

At shut off, with vacuum above the flat shutoff surface and air pressure below the flat shutoff surface, most of the air pressure forces are against the walls of the short tube. Those forces are radially outwardly directed, namely they are horizontal, and do not exert vertical force that would make the movable portion of the valve, namely the short tube, move in a vertical direction.

The surface of the end of the short tube at the short tube edge is a horizontal surface and can provide a small vertical force. For this reason, the preferred flow limiter uses a very thin wall short tube to minimize the horizontal surface area of the short tube.

In the preferred flow limiter, air flow rate in cubic feet per minute can be adjusted by adding or subtracting weight from the floating portion of the valve, or by adjusting the surface area of the sail, or by adjusting the size or shape of the sail in the air flow.

Accordingly, the preferred air flow limiter preferably has a vertically oriented tube, a pair of open-ended preferably telescoping tubular internal segments within the tube, with an outer tubular segment being fixed and the other being slidably moveable along the fixed segment in the axial direction. A plate preferably extends partially across the interior of the vertically oriented tube and is preferably positioned for contacting the moveable one of the telescoping tubular segments, limiting travel of the moveable telescoping tubular segment, with the plate preferably covering the upper, open end of the moveable telescoping tubular segment upon contact therewith. A sail is preferably positioned in the vertically oriented tube below the telescoping segments a strut connects the sail and the moveable telescoping tubular segment; and a baffle is positioned to direct upward air flow within the tube through the telescoping tubular segments; where the moveable telescoping tubular segment preferably moves vertically within the tube unitarily with the sail responsively to air flow upwardly through the tube against the sail.

The tubular segments are preferably cylindrical; the surface of the plate contacted by the moveable tubular segment is preferably planar; the portion of the moveable tubular segment contacting the plate surface is preferably annular.

In a variation of terminology (but not of structure), a surface of the plate contacted by the moveable tubular segment is flat, the tubular segments are cylindrical and the circular edge of the tubular segment contacting the plate service is annular and normal to the axis of the tubular segment.

The preferred air flow limiter may be viewed as consisting of a vertically oriented tube, a tubular segment within the tube, which segment is moveable in the axial direction, a plate extending at least partially across the interior of the tube for contacting the movable tubular segment and defining a limit of travel of the moveable tubular segment, a sail positioned in the tube below the moveable tubular segment and being moveable vertically within the tube, a strut connecting the tubular segment and the sail, and a baffle connected to and located within the tube defining a lower limit of travel of the moveable tubular segment upon contact of the strut with an upper extremity of the baffle. The moveable tubular segment is in sliding telescoping engagement with the tubular portion of the baffle, directing upward air flow within the tube, the moveable tubular segment being moveable unitarily with the sail in response to upward air flow through the tube contacting the sail.

The preferred air flow limiter may be considered as having a vertically oriented tube with a sail assembly positioned in the tube and being moveable therewithin responsively to air flow through the tube, to regulate air flow through the tube and to stop air flow thorough the tube upon air flow exceeding a preselected value.

In one of its aspects, this invention preferably places two or more air flow limiters in the resin or other granular material conveying system at key locations so that smaller, preferably 1.5 inch lines can be used for air flow for auxiliary devices, in addition to the conventional 2 inch lines for main resin conveyance. This permits a desired commodity, such as color pellets or some other additive, to be conveyed by air controlled by traveling through a lower size fixed air flow limiter and hence functioning to deliver granular resin material or other material granules to a receiver or to deliver an additive to that receiver.

Use of multiple flow limiters to allow different line sizes in the same resin or other granular material conveying system is an important aspect of this invention. Such use of multiple flow limiters, allowing use of different size conveyance lines, facilitates greater flexibility with consequent cost savings for the purchaser of the material conveying system.

### BRIEF DESCRIPTION OF THE DRAWINGS

FIG. 1 is a schematic view of a first vacuum powered conveyance system for delivery of granular plastic resin material or other granular material in accordance with aspects of the invention.

FIG. 2 is a schematic view of a second vacuum powered conveyance system for delivery of granular plastic resin material or other granular material in accordance with aspects of the invention.

FIG. 3 is a schematic view of a third vacuum powered conveyance system for delivery of granular plastic resin material or other granular material in accordance with aspects of the invention.

FIG. 4 is a schematic view of a fourth vacuum powered conveyance system for delivery of granular plastic resin material or other granular material in accordance with aspects of the invention.

FIG. 5 is a schematic view of a fifth vacuum powered conveyance system for delivery of granular plastic resin material or other granular material in accordance with aspects of the invention.

FIG. 6 is a schematic view of a sixth vacuum powered conveyance system for delivery of granular plastic resin material or other granular material in accordance with aspects of the invention.

FIG. 7 is a schematic view of a seventh vacuum powered conveyance system for delivery of granular plastic resin material or other granular material in accordance with aspects of the invention.

FIG. 8 is a schematic view of an eighth vacuum powered conveyance system for delivery of granular plastic resin material or other granular material in accordance with aspects of the invention.

FIG. 9 is a schematic isometric view of a receiver embodying aspects of the invention.

FIG. 10 is an isometric view of the exterior of a preferred air flow limiter.

FIG. 11 is a front elevation of the air flow limiter illustrated in FIG. 10.

FIG. 12 is an isometric sectional view of the air flow limiter illustrated in FIGS. 10 and 11, with the section taken at arrows XIII-XIII in FIG. 11.

FIG. 13 is a sectional view in elevation of the air flow limiter illustrated in FIGS. 10, 11, and 12, with the section taken at lines and arrows XIII-XIII in FIG. 11, with air flow through the air flow limiter being depicted in FIG. 13 by unnumbered curved dark arrows.

FIG. 14 is a sectional view in elevation similar to FIG. 13 but with the air flow limiter internal parts in position whereby there is no air entering the air flow limiter and hence there is no air flow upwardly through the air flow limiter, in contrast to such air flow being shown in FIG. 13.

FIG. 15 is a sectional view in elevation, similar to FIGS. 13 and 14, but with the air flow limiter internal parts in position where there is an excessive amount of air attempting to enter the air flow limiter but there is no air flow upwardly through the air flow limiter due to the air flow limiter valve having moved to block air flow upwardly through the air flow limiter, in contrast to air flow upwardly through the air flow limiter as shown in FIG. 13.

FIG. 16 is an exploded isometric view of the air flow limiter illustrated in detail in FIGS. 10 through 15.

FIG. 17 is an isometric view of the movable portion of the air flow limiter valve illustrated in FIGS. 10 through 16.

FIG. 18 is a sectional view of an air flow limiter similar to that shown in FIGS. 13, 14 and 15, illustrating an alternate construction of the baffle portion of the air flow limiter.

FIG. 19 is sectional view of an air flow limiter similar to that shown in FIGS. 13, 14, 15 and 18, illustrating a second alternate construction of the baffle portion of the air flow limiter.

### DESCRIPTION OF PREFERRED IMPLEMENTATIONS

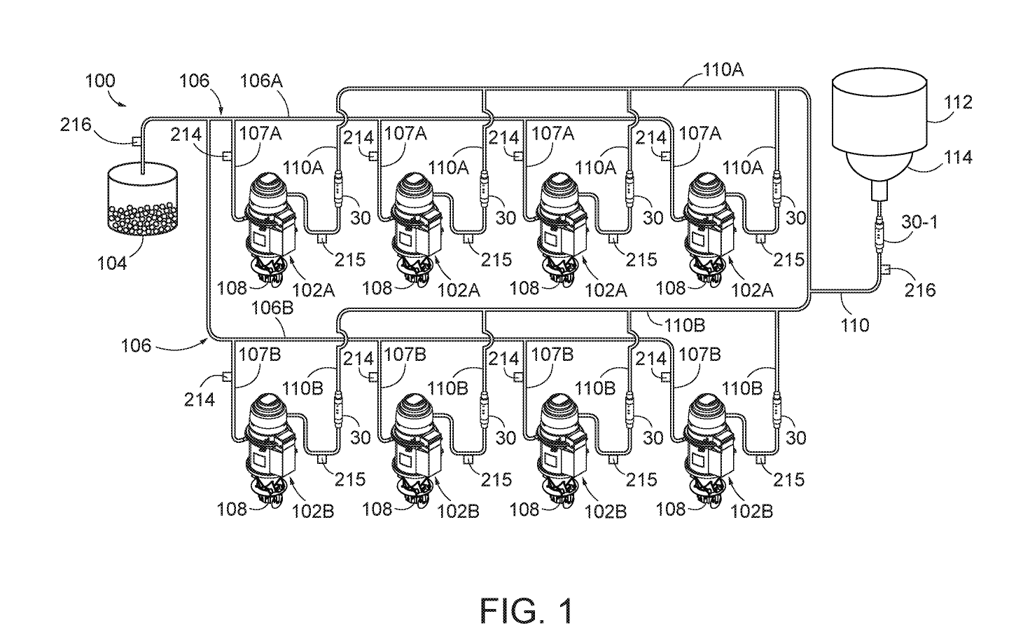

Referring to the drawings in general and to FIG. 1 in particular, apparatus for delivery of granular plastic resin material or other granular material in accordance with the invention is designated generally 100. Apparatus 100 conveys granular plastic resin material or other granular material from a resin material or other material supply 104 to a plurality of receivers, each of which is designated either 102A or 102B in FIG. 1. The resin or other material granules are conveyed from resin material supply 104 to receivers 102A, 102B via resin or other granular material conveyance conduits that are designated generally 106, where 106A denotes a first resin or other granular material conveyance conduit and 106B denotes a second resin or other granular material conveyance conduit.

First resin or other granular material conveyance conduit 106A conveys resin or other material granules from supply 104 to receivers 102A that are shown generally aligned in the upper portion of FIG. 1. Second resin or other granular material conveyance conduit 106B conveys resin or other material granules from supply 104 to receivers 102B that are shown generally aligned in the lower portion of FIG. 1. First and second resin or other granular material conveyance conduits 106A, 106B are preferably, but not necessarily, of the same diameter and convey resin or other material granules to the respective receivers 102A, 102B under vacuum drawn by vacuum pump 112.

Each receiver 102A, 102B is depicted as having a resin or other granular material discharge conduit 108 at the bottom thereof for discharge of resin or other material granules when needed from the associated receiver. Resin or other granular material is discharged upon demand by a process machine requiring additional resin or other granular material to continue manufacture of molded or extruded plastic parts. Receivers 102A and 102B are preferably all identical.

As depicted schematically in FIG. 1, resin or other material granules are supplied to receivers 102A, 102B from above, with resin or other granular material supply lines 107A connecting receivers 102A with a first resin or other granular material conveyance conduit 106A and with resin or other granular material supply lines 107B connecting receivers 102B with a second resin or other granular material conveyance conduit 106B. The respective resin or other granular material supply lines 107A, 107B lead into particular receivers 102A, 102B in order to deliver resin or other material granules thereto. Resin or other granular material is conveyed through resin or other granular material conveyance conduits 106A, 106B due to vacuum drawn by vacuum pump 112.

Air drawn under vacuum by vacuum pump 112 leaves from each receiver 102 via an air/vacuum discharge conduit designated 110A or 110B. Each receiver air discharge conduit 110A, 110B leads initially to an air flow limiter 30. Air as vacuum leaving a receiver 102A, 102B, after passing through an air flow limiter 30, travels on through the associated receiver air/vacuum discharge conduit 110A, 110B, with air/vacuum discharge conduits 110A and 110B joining as illustrated at the right side of FIG. 1. Air as vacuum coming from receiver air/vacuum discharge conduits 110A and 110B combines and passes through another air flow limiter 30-1 before reaching vacuum pump 112.

Vacuum pump 112 is desirably equipped with a variable electrical frequency drive motor 114, allowing precise control of vacuum pump 112.

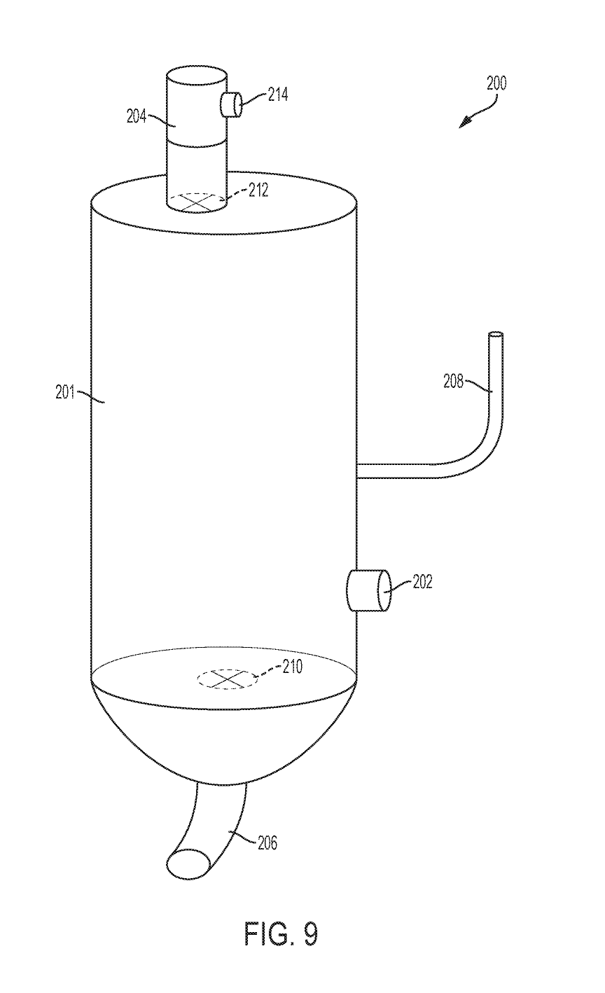

Each receiver 102 is desirably of the type shown schematically in FIG. 9 and described in greater detail hereinbelow.

In the embodiment illustrated in FIG. 1, each receiver 102A, 102B has an air flow limiter 30 associated directly with the receiver. Each receiver has an air/vacuum discharge conduit 110 leading directly into an air flow limiter 30 associated with that particular receiver. Each air flow limiter 30 is preferably of the type described hereinbelow in greater detail.

Air flow limiters 30 are all preferably identical. Air flow limiter 30-1 is desirably of larger size and hence of larger capacity than air flow limiters 30. However, air flow limiter 30-1 is preferably of the same design as air flow limiters 30, as disclosed above.

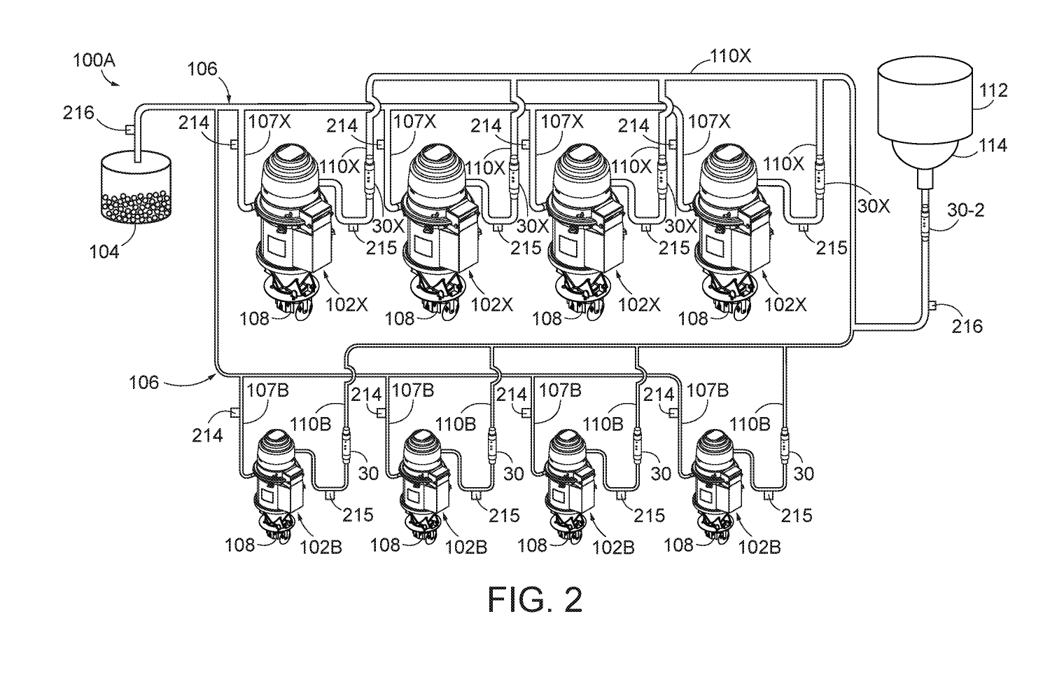

Still referring to the drawings and to FIG. 2 in particular, a second embodiment of apparatus for delivery of granular plastic resin material or other granular material in accordance with the invention is designated generally 100A. Much like apparatus 100 illustrated in FIG. 1, apparatus 100A conveys granular plastic resin material or other material granules from a resin material or other granular material supply 104 to a plurality of receivers. In the apparatus illustrated in FIG. 2, the receivers are two different sizes. The smaller receivers are designated 102B, while the larger receivers are designated 102X.

Similarly to the apparatus illustrated in FIG. 1, the resin or other granular material is conveyed from raw material supply 104 to receivers 102B, 102X via resin or other granular material conveyance conduits that are designated generally 106, where 106X denotes a first resin or other granular material conveyance conduit and 106B denotes a second resin or other granular material conveyance conduit. First resin or other granular material conveyance conduit 106X conveys resin or other material granules from supply 104 to resin or other granular material delivery lines 107X for delivery to receivers 102X. Second resin or other granular material conduit 106B conveys resin or other material granules from supply 104 to resin or other granular material supply lines 107B for delivery to receivers 102B. Since receivers 102X are larger than receivers 102B, receivers 102X generally have larger capacity for storage of resin or other granular material therein. Consequently, resin or other granular material conveyance conduit 106X and resin or other granular material supply or delivery lines 107X may be of larger diameter than resin or other granular material conveyance conduit 106B and resin or other granular material supply or delivery lines 107B, which convey resin or other material granules to smaller receivers 102B. Despite their possible different diameters, both resin or other granular material conveyance conduits 106X and 106B convey resin or other material granules to respective receivers 102X and 102B as a result of vacuum, desirably drawn by a single vacuum pump 112.

Similarly to FIG. 1, each receiver 102B, 102X has a resin or other granular material discharge conduit 108 at the bottom thereof for discharge of resin or other material granules when needed from the associated receiver 102B or 102X. Resin or other granular material is discharged upon demand by a process machine requiring additional resin or other granular material to continue manufacture of molded or extruded parts.

As depicted schematically in FIG. 2, similarly to that shown in FIG. 1, resin or other material granules are supplied to each receiver 102B, 102X preferably from above, with resin or other granular material supply lines 107B, 107X connecting to either first resin or other granular material conveyance conduit 106X or second resin or other granular material conveyance conduit 106B leading into a particular receiver 102X or 102B in order to deliver resin or other material granules thereinto. All resin or other material granules are conveyed through the resin or other granular material conveyance conduit 106, specifically resin or other granular material conveyance conduits 106B and 106X, due to vacuum drawn by vacuum pump 112.

Similarly to the arrangement shown in FIG. 1, air drawn under vacuum by a vacuum pump 112 leaves from each receiver 102A, 102 via an air/vacuum discharge conduit designated 110X or 110B, according to whether the discharge conduit is associated with a receiver 102X or a receiver 102. Each receiver air/vacuum discharge conduit, whether it be air/vacuum discharge conduit 110X or air/vacuum discharge conduit 110B, leads initially to an air flow limiter that is associated with a particular receiver, with the air flow limiter being designated 30X if associated with a receiver 102X or with the air flow limiter being designated 30 if associated with a receiver 102B. Air/vacuum leaving a receiver 102X or 102B, after passing through the associated air flow limiter 30X or 30, travels through the associated receiver air discharge conduit 110X or 110B with discharge conduits 110X and 110B joining as illustrated at the right side of FIG. 2. Air/vacuum coming from receiver air/vacuum discharge conduits 110X and 110B combines and preferably passes through another flow limiter, this flow limiter being designed 30-2, before reaching vacuum pump 112. Desirably flow limiter 30-2 is of larger capacity than either flow limiter 30 or flow limiter 30X due to the relevant portions of resin conveyance conduit 106X, receivers 102X, and air flow limiters 30X and air/vacuum discharge conduits 110X being larger than the corresponding components and conduits illustrated in FIG. 1.

Vacuum pump 112, similarly to vacuum pump 112 illustrated in FIG. 1, is desirably equipped with a variable frequency drive unit 114, allowing precise control of vacuum pump 112.

Similarly to FIG. 1, each receiver 102X, 102B is desirably of a type shown schematically in FIG. 9 described in greater detail below.

Similarly to the apparatus illustrated in FIG. 1, each receiver 102X, 102B has an air flow limiter 30X, 30 associated directly with the receiver. Air flow limiters 30X being associated with larger size receivers 102X may be of larger size and hence larger capacity than air flow limiters 30. Similarly, air flow limiter 30-2 may be of still larger size and hence of still larger capacity than air flow limiters 30X. Desirably, air flow limiters 30X and 30-2 are of the same design as air flow limiter 30, as disclosed hereinbelow.

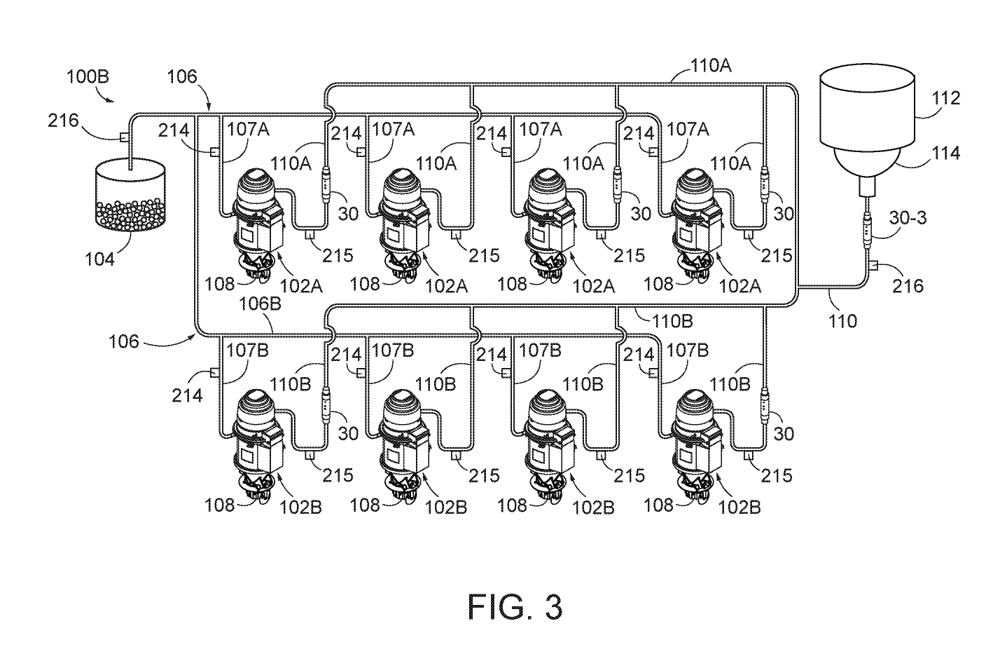

Referring to FIG. 3, apparatus for delivery of granular plastic resin material or other granular material in accordance with the invention is designated generally 100B. Apparatus 100B conveys granular resin material or other granular material from a resin material or other granular material supply 104 to a plurality of receivers, each of which is designated either 102A or 102B in FIG. 3, in the same manner as in FIGS. 1 and 2. The resin or other material granules are conveyed from resin material or other granular material supply 104 to receivers 102A, 102B initially via resin or other granular material conveyance conduits that are designated generally 106, where 106A denotes a first resin or other granular material conveyance conduit and 106B denotes a second resin or other granular material conveyance conduit, and then via resin supply lines 107A, 107B to invidual receivers 102A or 102B.

Similarly to FIG. 1, first resin or other granular material conveyance conduit 106A conveys resin or other material granules from supply 104 to receivers 102A that are shown in the upper portion of FIG. 3. Second resin or other granular material conveyance conduit 106B conveys resin or other material granules from supply 104 to receivers 102B that are shown in the lower portion of FIG. 3. First and second resin or other granular material conveyance conduits 106A, 106B are preferably, but not necessarily, of the same diameter and convey resin or other material granules to the respective receivers 102A, 102B as a result of vacuum drawn by vacuum pump 112. Each receiver 102A, 102B is depicted as having a resin or other granular material discharge conduit 108 at the bottom thereof for discharge of resin or other granular material when needed from the associated receiver 102A or 102B. Resin or other material granules are discharged upon demand by a process machine requiring replenishment of resin in order to continue manufacture of molded or extruded plastic parts.

As depicted schematically in FIG. 3, similarly to FIG. 1, resin or other material granules are supplied to each receiver 102A or 102B, with first resin or other granular material supply conduits 107A leading from first resin or other granular material conveyance conduit 106A into receivers 102A and with second resin or other granular material supply conduits 107B leading from second resin or other granular material conveyance conduit 106B into receivers 102B to deliver resin or other material granules thereinto. Resin or other material granules are conveyed through conveyance conduits 106A, 106B and resin supply conduits 107A and 107B due to vacuum drawn by vacuum pump 112.

Air drawn under vacuum by vacuum pump 112 from each receiver departs that receiver, either 102A or 102B, via air/vacuum discharge conduit designated 110A or 110B. Air/vacuum discharge conduits 110A and 110B discharge air as vacuum from an associated receiver 108 initially through an air limiter 30, if an air limiter 30 is present. Air as vacuum leaving a receiver 102A or 102B either through discharge conduit 110A or 110B, after passing through an associated air flow limiter 30 if present, travels on through the receiver discharge conduits 110A or 110B to a point of juncture of the two, and from there via discharge conduit 110 through air flow limiter 30-3 to vacuum pump 112.

In the embodiment illustrated in FIG. 3, some receivers 102A, 102B do not have an air flow limiter 30 directly associated therewith. Air drawn under vacuum by vacuum pump 112 leaves those receivers via an “air-as-vacuum” discharge conduit designated 110A or 110B. Air leaving a receiver 102A or 102B via an “air-as-vacuum” discharge conduit 110A or 110B lacking an air flow limiter 30 joins a main discharge conduit 110A or 110B as illustrated and passes through flow limiter 30-3 before reaching vacuum pump 112.

Similarly to the apparatus depicted in FIGS. 1 and 2, vacuum pump 112 in FIG. 3 is desirably equipped with a variable frequency drive unit 114 allowing precise control of vacuum pump 112. Further similarly to FIGS. 1 and 2, each receiver, whether numbered 102A or 102B, is desirably of the type shown schematically in FIG. 9 and described in greater detail hereinbelow, and the receivers are all the same size as in FIG. 1. Each air flow limiter 30, as well as flow limiter 30-3, is preferably of the type described hereinbelow in greater detail.

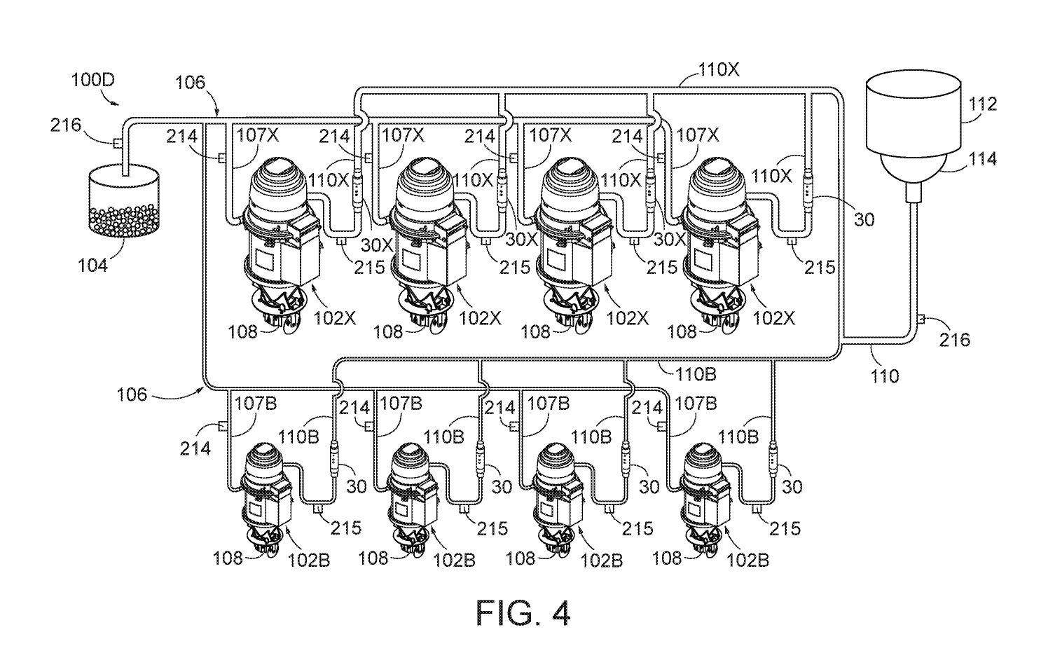

Referring to FIG. 4, apparatus for delivery of granular plastic resin material in accordance with the invention is designated generally 100D. Apparatus 100D is similar to apparatus 100A illustrated in FIG. 2 with the exception that there is no flow limiter 30-2 in resin conveyance conduit 110 leading immediately to vacuum pump 112 and vacuum pump variable frequency drive 114. Operation of the apparatus illustrated in FIG. 4 is similar to operation of the apparatus illustrated in FIG. 2, with the exception that flow limiters 30, 30X in FIG. 4 may be internally configured differently and sized differently to account for the absence of any flow limiter 30-2 of the type illustrated in FIG. 2 in conduit 110 leading directly to vacuum pump 112.

With each receiver 102B, 102X in FIG. 4 having air flow limiter 30 or 30X associated therewith, presence of an air flow limiter such as 30-2 illustrated in FIG. 2, in the position illustrated in FIG. 2, is not so critical to successful operation of the system without central control. Where some receivers do not have air flow limiters associated with them, as in the embodiment illustrated in FIG. 3, presence of an air flow limiter such as air flow limiter 30-3 in FIG. 3, positioned just upstream from vacuum pump 112, is important for the successful operation of the system without central control.

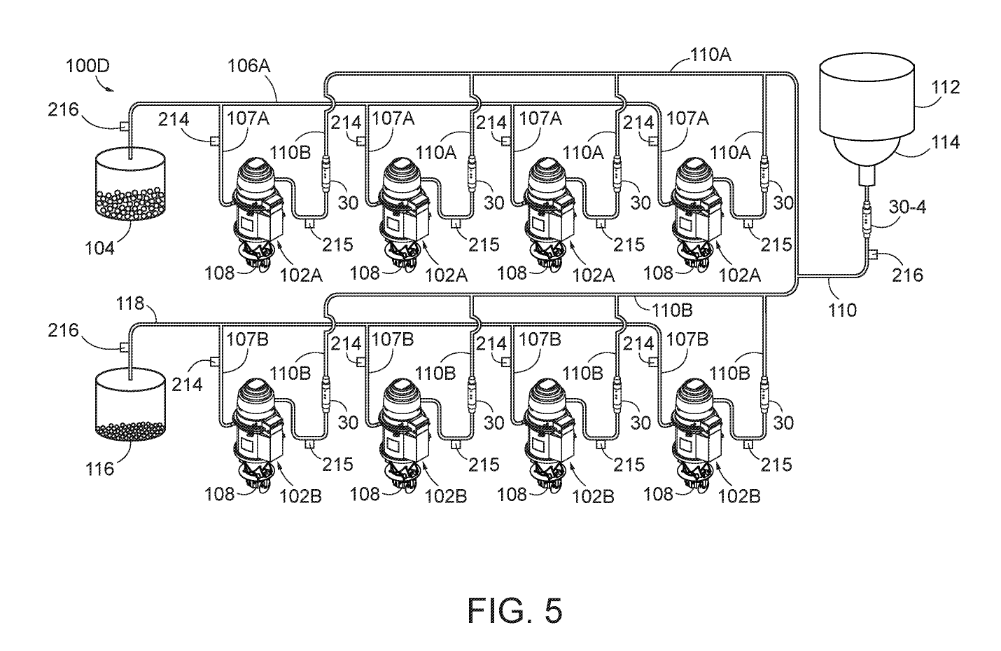

Referring to FIG. 5, apparatus for delivery of granular plastic resin material or other granular material in accordance with the invention is designated generally 100D. Apparatus 100D is similar to apparatus 100 illustrated in FIG. 1 but in FIG. 5 receivers 102A receive granular plastic resin material or other granular material to be processed from resin material or other granular material supply 104 while receivers 102B receive other material, which can be other granular plastic resin material, other material granules, or additives, or solid colorant, from a material supply 116. Since a given process, whether extrusion or molding, may require different amounts of granular plastic resin material or other granular material from supply 104 and granular plastic resin material, other granular material or additive or solid colorant from supply 116, material from supply 104 and material from supply 116 travel through separate conveyance conduits which have been numbered 106A and 118 in FIG. 5. Similarly, the receivers in FIG. 5 have been designated 102A and 102B to be consistent with the numbering of the smaller receivers throughout this disclosure. Receivers 102A, 102B are preferably of the type disclosed herein and illustrated in FIG. 9.

Similarly to the configuration illustrated in FIG. 1, a first resin or other granular material conveyance line 106A conveys granular plastic resin material or other granular material from supply 104 to receivers 102A via resin or other granular material supply lines 107A. A material conveyance line 118 conveys material from supply 116 to receivers 102B. Conveyance lines 106A, 118 are of suitable size according to the volume of material being conveyed from supplies 104 and 116 to receivers 102A and 102B. As is the case with the configurations illustrated in FIGS. 1 through 4, all conveyance of materials in the apparatus illustrated schematically in FIG. 5 is pneumatic conveyance performed by a vacuum pump 112 desirably having a variable speed drive 114 associated therewith, as illustrated schematically in FIG. 5.

Similarly to the apparatus illustrated in FIGS. 1 through 4, each receiver 102A, 102B has a discharge conduit at the bottom thereof for discharge of material when the material is needed from the associated receiver 102A or 102B by a process machine. Material is discharged upon demand upon a process machine requiring additional material to continue manufacture of molded or extruded plastic parts. The discharge conduits of receivers 102A, 102B are designated 108 for consistency with the discharge conduits of the receivers in FIGS. 1 through 4.

Similarly to the system illustrated in FIG. 1, the receivers illustrated in FIG. 5 all have associated therewith a flow limiter where the flow limiters have been designated 30. As with the flow limiters 30 illustrated in FIG. 1 and as set forth elsewhere in this application, flow limiters 30 will be appropriately sized according to the size of the pneumatic conveyance conduit and the design goal flow rate of the conduit with which a given flow limiter is associated. As illustrated in FIG. 5, each receiver 102A, 102B has a flow limiter 30 associated therewith to limit flow through the receiver as drawn by vacuum pump 112 and its controlling variable speed drive 114.

As further illustrated in FIG. 5, first and second pneumatic conveyance conduits 110A, 110B come together before reaching vacuum pump 112. Downstream of juncture of first and second pneumatic conveyance conduits 110A, 110B is a flow limiter 30-4. Provision of the flow limiters 30 and 30-4, together with the self-regulating character of receivers 102A, 102B, as such self-limiting character is described with respect to the receiver illustrated in FIG. 9, allows the vacuum powered resin loading systems illustrated in drawing FIGS. 1 through 8 to operate without central control.

Further respecting the configuration illustrated in FIG. 5, similarly to that depicted schematically in FIG. 1 material is supplied to each receiver 122, 124 with a portion of either first material conveyance line 107A or second material conveyance line 107B leading into a particular receiver 102A, 102B to deliver material thereto. Material is conveyed through first and second material conveyance lines 106A, 118 due to vacuum drawn by vacuum pump 112.

Also similarly to FIG. 1, in the system configuration illustrated in FIG. 5 as apparatus 100D, air drawn under vacuum by vacuum pump 112 leaves each receiver 102A, 102B via an “air-as-vacuum” discharge conduit designated 110A or 110B, according to whether the discharge conduit is associated with a receiver 102A or 102B. Both first and second pneumatic conveyance conduits 110A, 110B feed initially to an air flow limiter 30. Air leaving a receiver 102A or 102B, after passing through the associated air flow limiter 30, continues traveling on through the associated “air-as-vacuum” discharge conduit 110A or 110B, with those conduits joining as illustrated at the right side of FIG. 5. As with FIG. 1, each receiver 102A, 102B has an air flow limiter 30 associated directly with it. The receiver “air-as-vacuum” discharge conduit 110A, 110B for a given receiver leads directly from the receiver 102A, 102B to the associated air flow limiter 30 associated with the respective receiver 102A, 102B. Each air flow limiter 30 is preferably of the type described hereinbelow in greater detail.

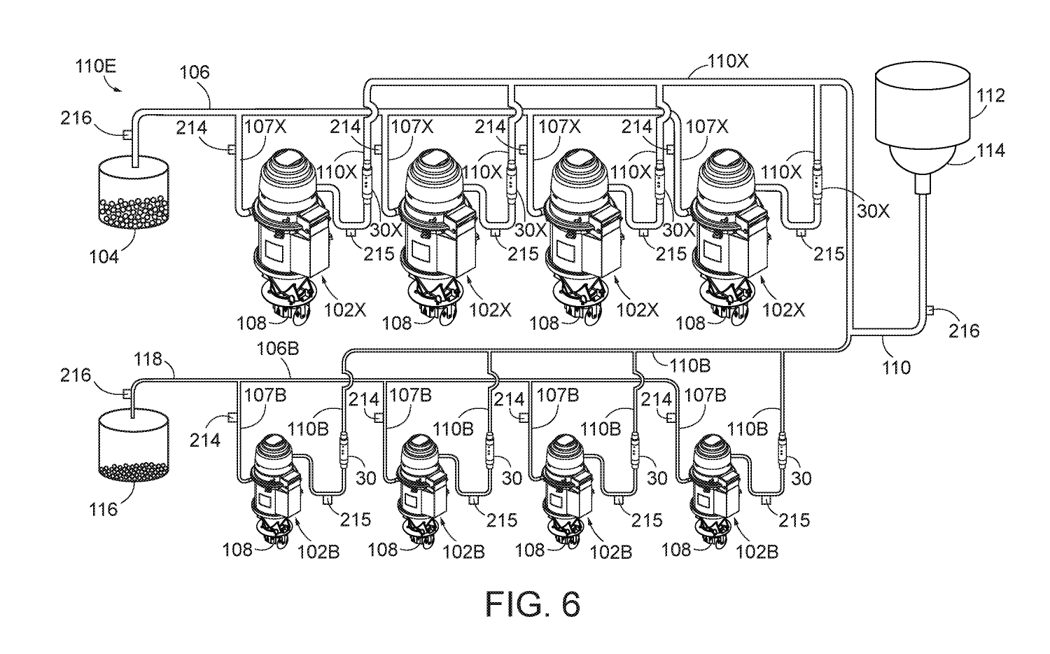

FIG. 6 illustrates yet another embodiment of apparatus for delivery of granular plastic resin material or other granular material and other associated materials such as regrind or virgin granular plastic resin material, solid colorant, etc., in accordance with the invention, with the apparatus being designated generally 100E. Much like apparatus 100A illustrated in FIG. 1, apparatus 100E conveys granular plastic resin material or other material granules from a resin material or other granular material supply 104 to a plurality of receivers 102X. In the apparatus illustrated in FIG. 6, the receivers 102X receiving granular plastic resin material or other granular material from supply 104 are illustrated to be of a larger size than receivers 102B receiving a second type of granular resin material, or additive, or colorant, or a mixture thereof, from supply 116 via conduit 118. In FIG. 6, the smaller receivers designated 102B receive the other material, such as a different type of granular resin material, virgin granular resin material, regrind resin material or colorant, or other granular material, from supply 116.

In FIG. 6, a first pneumatic conveyance conduit serving to pneumatically convey granular plastic resin material or other granular material from supply 104 to receivers 102X is designated 106, while a second pneumatic conveyance conduit for conveying material from supply 116 to receivers 102B is designated 118. In FIG. 6 materials carried from supply 104 via conveyance conduit 106 to individual material supply lines 107X leading to receivers 102X. Material is discharged from receivers 102X via granular material discharge conduit 108 as needed by an associated process machine. Vacuum leaves receiver 102X via an air/vacuum discharge conduit 110X and passes through an air limiter 30X positioned in air/vacuum discharge conduit 110 between the associated receiver 102X and a position at which air/vacuum discharge conduit 110X joins with air/vacuum conduit 110B to form a preferably larger air/vacuum discharge conduit 110 and for flow on to vacuum pump 112.

Still referring to FIG. 6, material from a secondary supply 116 is conveyed through a conveyance conduit 118 by vacuum drawn by vacuum pump 112. Individual receivers 102B receive material from supply 116 and supply conduit 118 via individual material supply lines 107B. Air as vacuum departs receivers 102B through air/vacuum discharge conduits 110B all of which join together and lead to a position of juncture with air/vacuum discharge conduit 110X for flow onward through air/vacuum discharge conduit 110 to vacuum pump 112. An air flow limiter 30 is positioned within each air/vacuum discharge conduit 110B associated with each receiver 102B in FIG. 6.

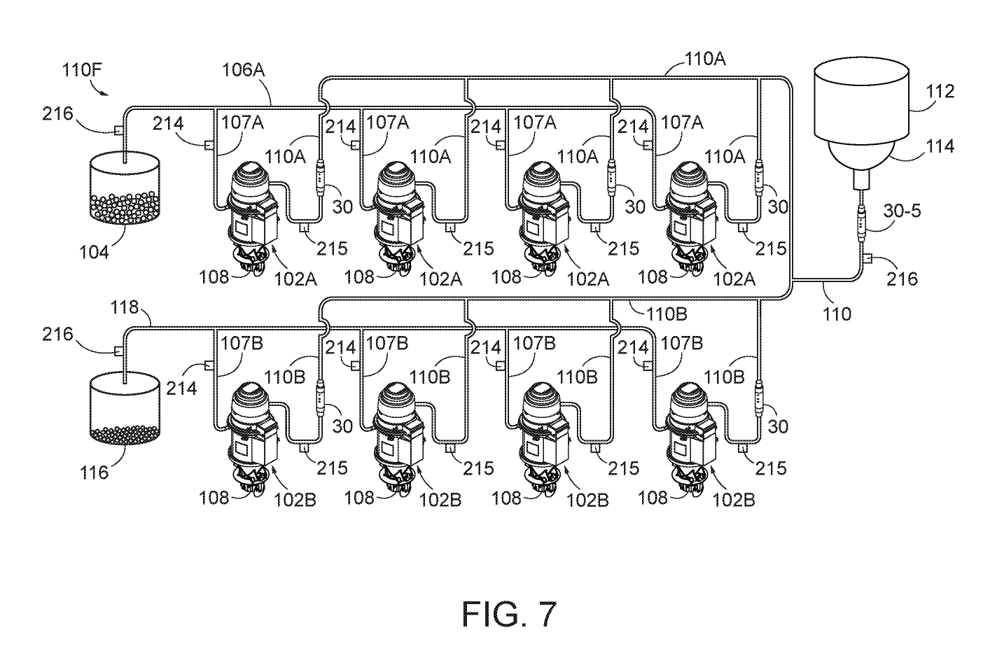

Referring to FIG. 7, apparatus for delivery of granular plastic resin material or other granular material in accordance with the invention is designated generally 100F. Apparatus 100F is similar to apparatus 100 illustrated in FIG. 1, but in FIG. 7 receivers 102A receive granular resin plastic material or other granular material to be processed from a resin material or other material granule supply 104 while receivers 102B receive other material, which can be other granular plastic resin material, other granular material, or additives, or solid colorant, from material supply 116. This is similar to the arrangement illustrated in FIG. 6; however, in FIG. 7, all receivers are the same size.

Since a given process, whether extrusion or molding, may require different amounts of granular plastic resin material or other granular material from supply 104 and granular plastic resin material, other granular material, or additive material, or solid colorant from supply 116, material from supply 104 and material from supply 116 travel through separate conveyance conduits numbered 106A and 118 in FIG. 7. Similarly, receivers in FIG. 7 have been designated 102A and 102B to be consistent with the numbering of the similar, smaller receivers throughout this disclosure. Receivers 102A, 102B are preferably of the type disclosed herein as set forth below and as illustrated in FIG. 9.

Still referring to FIG. 7, similarly to the configurations illustrated in FIG. 6 and in FIG. 5, a first resin or other granular material conveyance line 106 conveys granular plastic resin material or other granular material from supply 104 to receivers 102A via resin or other granular material supply lines 107A. A material conveyance line 118 conveys material from supply 116 to receivers 102B. Conveyance lines 106A, 118 are of suitable size according to the volume and speed of material being conveyed from supplies 104 and 116 to receivers 102A and 102B. As is the case with the configurations illustrated in FIGS. 1 through 6, all conveyance of materials in the apparatus illustrated schematically in FIG. 7 is pneumatic conveyance performed by a vacuum pump 112 desirably having a variable speed drive 114 associated therewith, as illustrated schematically in FIG. 7.

Similarily to FIGS. 1 through 6, each receiver 102A, 102B in FIG. 7 has a discharge conduit at the bottom thereof for discharge of material when the material is needed from the receiver 102A or 102B by an associated process machine. Material is discharged on demand from the receiver upon a process machine requiring additional material to continue manufacture of molded or extruded plastic parts. Discharge conduits of receivers 102A, 102B are designated 108 for consistency with the discharge conduits associated with receivers illustrated in FIGS. 1 through 6.

Unlike the apparatus illustrated in FIG. 1 and unlike the apparatus illustrated in FIGS. 5 and 6, not all receivers 102A, 102B illustrated in FIG. 7 have an associated flow limiter. Flow limiters, where present and associated with a receiver 102A, 102B in FIG. 7 are designated 30, consistently with the practice of FIGS. 1 through 6. As with flow limiters 30 illustrated in other configurations of apparatus embodying the invention and as set forth elsewhere in this application, flow limiters 30 are appropriately sized according to the size of the pneumatic conveyance conduit and the design goal flow rate with which a given flow limiter is associated.

Since some receivers 102A, 102B illustrated in FIG. 7 do not have flow limiters 30 associated therewith, an overall system flow limiter 30-5 is immediately upstream of vacuum pump 112. Since certain of the receivers 102A, 102B lack flow limiters, presence of an overall system flow limiter such as flow limiter 30-5 in FIG. 7 is important for operation of the system without central control. Flow limiter 30-5 illustrated in FIG. 7 limits overall air flow throughout the entire system illustrated in FIG. 7 and thereby compensates for certain of the receivers 102A, 102B lacking a flow limiter 30 in association therewith. The position of flow limiter 30-5 is important, being between vacuum pump 112 and the position at which first and second pneumatic conveyance conduits 110A, 110B come together to form a single pneumatic conveyance conduit 110.

Further respecting the configuration of the apparatus shown schematically in FIG. 7, similarly to that depicted in the other drawing figures, material is supplied to each receiver 102A, 102B with a portion of either first material conveyance line 107A or second material conveyance line 107B leading into a particular receiver 102A, 102B to deliver material thereinto. Material is conveyed through first and second material conveyance lines due to vacuum drawn by vacuum pump 112.

Also similarly to the other disclosed configurations of apparatus embodying the invention, in FIG. 7, air drawn under vacuum by vacuum pump 112 leaves each receiver 102A, 102B via a “air-as-vacuum” discharge conduit designated 110A or 110B according to whether the discharge conduit associated with the receiver 102A or 102B. Some but not all of the first and second discharge conduits 110A, 110B lead initially to an air flow limiter 30; FIG. 7 illustrates the absence of air flow limiters 30 for some of receivers 102A, 102B. Each air flow limiter 30 is preferably of the type described hereinbelow in greater detail. Air flow limiter 30-5 is preferably of the type described hereinbelow in greater detail but is preferably of a larger size relative to limiters 30, due to the larger capacity needed to limit air flow throughout the entire system illustrated in FIG. 7. All receivers 102A, 102B illustrated in FIG. 7 are preferably of the type illustrated in FIG. 9.

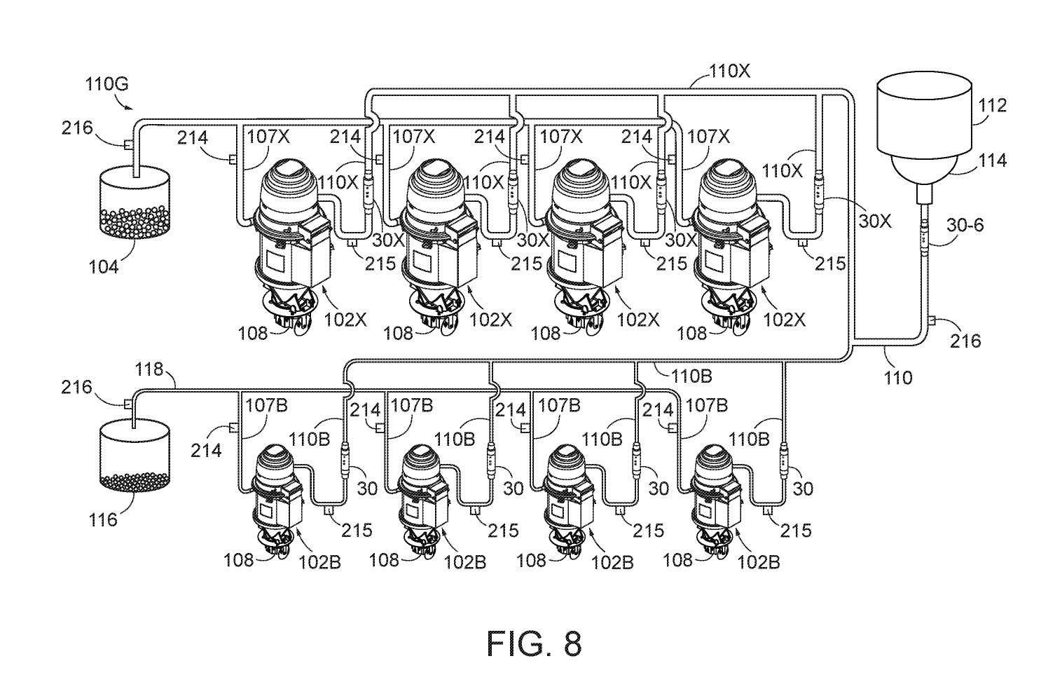

Referring to FIG. 8, apparatus for delivery of granular plastic resin material or other granular material in accordance with the invention is designated generally 100G. Apparatus 100G is similar to apparatus 100E illustrated in FIG. 6 with the exception that in FIG. 8, an overall system flow limiter 30-6 has been provided immediately upstream of vacuum pump 112. This is to provide redundant capacity for flow limiting since each of receivers 102B or 102X in FIG. 8 has an air flow limiter 30 or 30X associated with it. Other than the presence of system flow limiter 30-6 in FIG. 8, the apparatus of FIG. 8 and the operation thereof is essentially similar to the apparatus illustrated in FIG. 6.

Optional vacuum sensors 215 may be provided in downstream vacuum conveying conduits 110A, 110B, 110X as illustrated in the drawings. Optional vacuum sensors 215 provide an even greater degree of measurement with respect to the vacuum level in vacuum discharge conduits 110A, 110B, 110X, which vacuum level may result in “back pressure” in material supply lines 107A, 107B, 107X, which measurement may provide even greater control of the material delivery to a receiver 102A, 102B, or 102X when needed.

Vacuum sensors 215 are optional and when present may be connected to vacuum sensors 214 in a manner to close off vacuum supplied to an associated receiver 102A, 102B, 102X through a granular material vacuum supply line 107A, 107B, 107X, if needed. Connection between optional vacuum sensors 215 and associated vacuum sensors 214 has not been illustrated in the drawings preserve drawing clarity. The connection between optional vacuum sensors 215 and vacuum sensors 214 may be hardwired or may be wireless using Bluetooth, SMS, or even Internet technology. The hardwire connections and wireless signaling have not been illustrated in the drawings, to enhance drawing clarity.

Referring to FIG. 9 showing a receiver, in schematic form, in accordance with aspects of the invention, the receiver is designated generally 200 and includes a central body portion 201. Receiver 200 preferably includes a material inlet conduit designated 204 and a material outlet conduit designated 206 in FIG. 9. Receiver 200 preferably further includes a pneumatic outlet conduit designated 208 in FIG. 9, a material outlet valve designated 210 in FIG. 9, and a material inlet valve designated 212 in FIG. 9.

Receiver 200 further preferably includes a receiver material level sensor 202 for sensing the level of material within receiver 200 and providing a suitable signal when the material reaches a low enough level that replenishment of material in receiver 200 is required.

Receiver 200 further preferably includes a vacuum level sensor 214 positioned in material inlet conduit 204, just upstream of material inlet valve 212. Vacuum level sensor 214 determines when the level of vacuum in the pneumatic conveying system (which is not illustrated in FIG. 9 but is understood to be of any of the types illustrated in FIGS. 1 through 8) connected to material inlet conduit 204, is excessively low for receiver 200 to draw granular material through material inlet conduit 204 in response to the vacuum drawn by a vacuum pump acting through pneumatic outlet conduit 208. Vacuum level sensors 214 are depicted schematically in FIGS. 1 through 8.

Receiver 200 as illustrated in FIG. 9 is the preferred implementation of a receiver for use in the pneumatic conveying systems of the invention. All of the receivers designated 102A, 102B, and 102X in FIGS. 1 through 8 are preferably of the type illustrated in FIG. 9 and designated 200. Vacuum level sensor 214 operates to control opening and closing of material inlet valve 212, with vacuum level sensor 214 keeping material inlet valve 212 closed so long as vacuum level in material inlet conduit 204 is too low for receiver 200 to load successfully. The vacuum level in material inlet conduit 204 reflects what is going on elsewhere in the pneumatic conveying system, for instance a vacuum pump 112 is pulling sufficient vacuum in order to draw granular plastic resin material or other granular material through the pneumatic conveyance lines of the pneumatic material conveying system. If the sensed vacuum level is too low for successful loading of receiver 200, vacuum level sensor 214 maintains material inlet valve 212 closed. In such case, with receiver 200 essentially being out of the system, receiver 200 cannot contribute to a further drop in vacuum (actually an increase in air pressure) in the system.

With reference to FIGS. 1 through 9, as numerous ones of the illustrated receivers operate independently one of another, the pneumatic material conveying system is self-correcting. Specifically, as the vacuum pump continues to pull vacuum, as a receiver such as receiver 200 senses that the level of vacuum is too low for the receiver to successfully load with material, the receiver (through operation of vacuum level sensor 214) keeps material inlet valve 212 closed, thereby preventing a further “drop” of vacuum level in the system. It is to be understood that a “drop” in vacuum or vacuum level actually means an increase in air pressure within the system. Similarly, an “increase” in vacuum or vacuum level actually means a reduction in air pressure within the system due to a vacuum pump “pulling” more vacuum in the system.

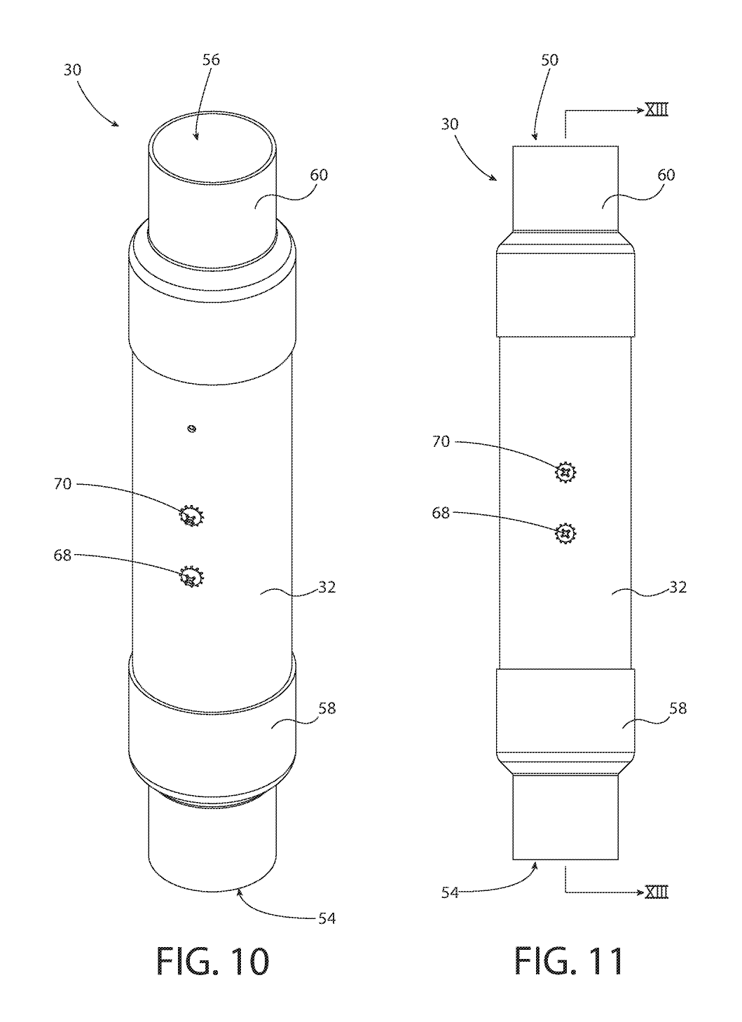

Referring principally to FIGS. 10 through 19 in general and to FIG. 10 in particular, a most preferred air flow limiter 30 is preferably in the general form of a vertically oriented tube, preferably having inlet and outlet ends 54, 56 respectively. The tubular character of air flow limiter 30 is apparent from FIGS. 10 through 15, where air flow limiter 30 preferably includes a vertically oriented exterior tube 32, with open-end caps 58, 60 defining and providing open inlet and outlet ends 54, 56 respectively. End caps 58, 60 are open, of generally cylindrical configuration, and are configured to fit closely about vertically oriented tube 32 so as to provide a substantially air tight fit between end caps 54, 56 and tube 32.

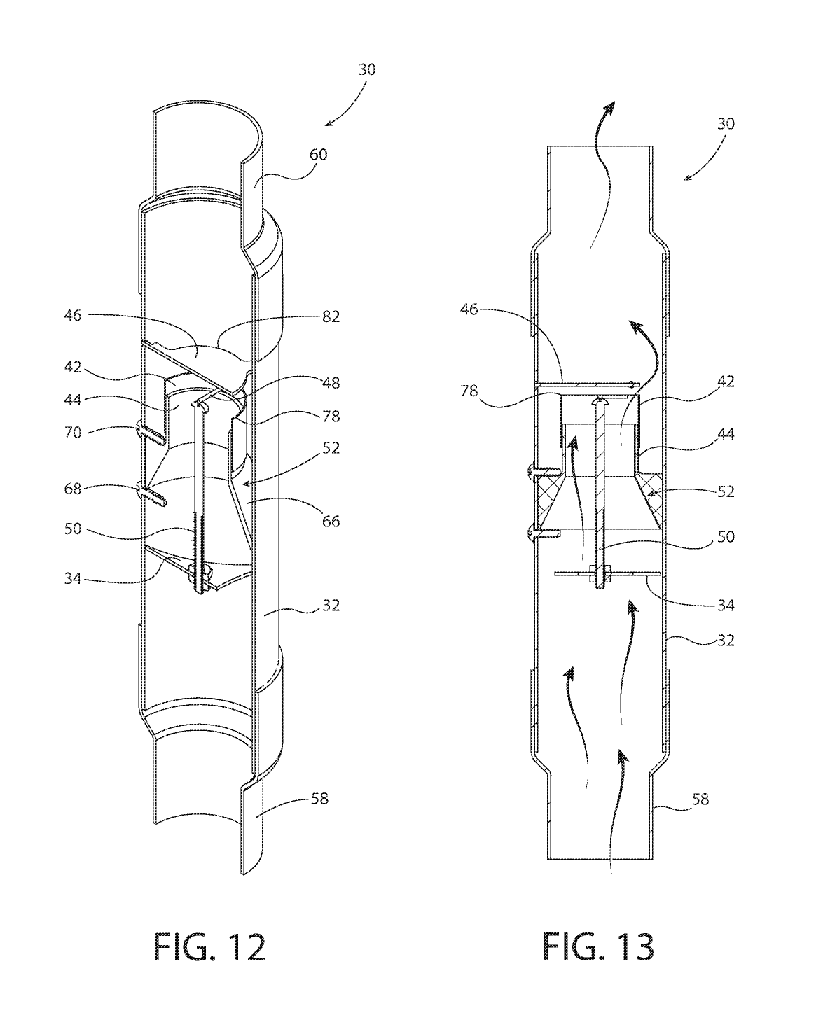

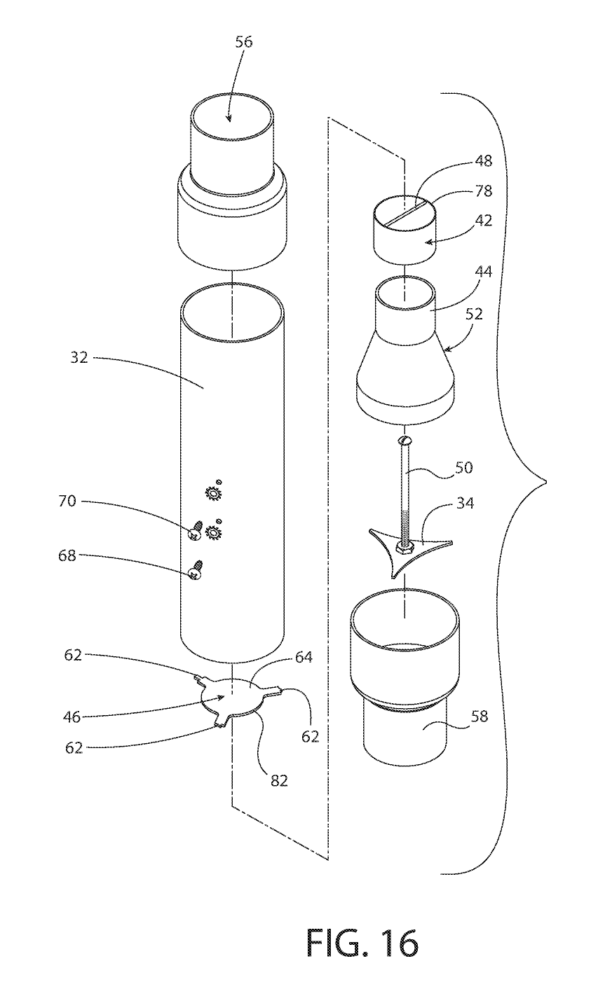

As illustrated in FIG. 12, air flow limiter 30 preferably includes, within vertically oriented exterior tube 32, a horizontally positioned plate 46, which is oriented perpendicularly to the axis of tube 32. Plate 46 is preferably configured as a circular disk of lesser diameter than the inner diameter of vertically oriented tube 32, with plate 46 further preferably including three legs extending outwardly from the circular interior disk portion of plate 46. Legs of plate 46 are designated 62 in FIG. 16, while the circular interior portion of plate 46 is designated 64 in FIG. 16. Plate 46 is secured to the interior of vertically oriented outer tube 32 by attachment of legs 62 to the interior surface of tube 32. Any suitable means of attachment, such as by welding, adhesive, mechanical screws, or end portion of legs 62 defining tabs fitting into slots within tube 32 as shown in FIG. 12, may be used.

As best shown in FIGS. 12, 13, and 14, a baffle 52 is positioned within vertically oriented outer tube 32 below plate 46. Baffle 52 has a lower conical portion 66 and an upper cylindrical portion 44, with cylindrical portion 44 defining a fixed internal tubular segment of air flow limiter 30. Baffle 52 is preferably retained in position by a pair of screws designated 68, 70 respectively. Baffle 52 preferably rests on screw 68. Screw 70 preferably fits against the fixed internal tubular segment 44 portion of baffle 52 to secure baffle 52 in position within vertically oriented external tube 32. Lateral force applied by screw 70 in a direction perpendicular to the axis of vertically oriented external tube 32, with screw 70 in contact with fixed internal tubular segment 44, serves to effectively retain baffle 52 against movement within vertically oriented external tube 32.

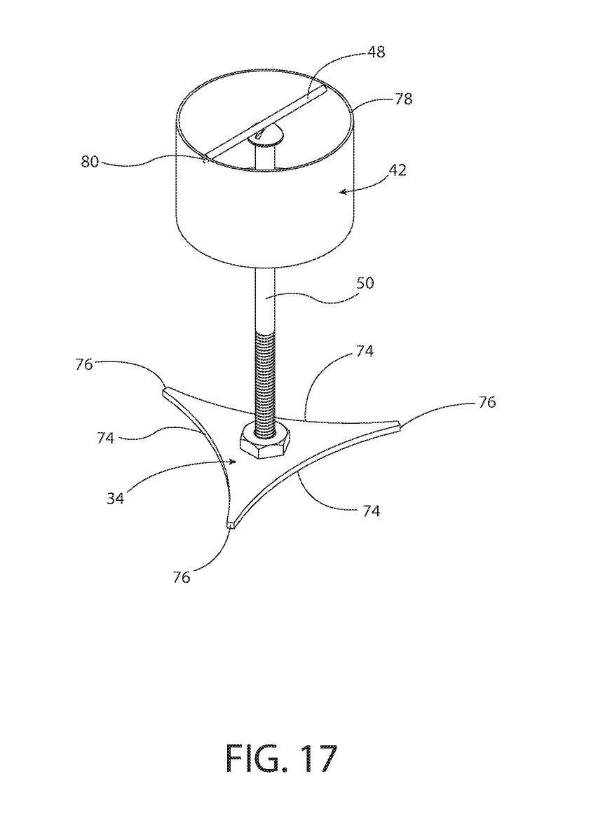

The upper portion of baffle 52, defining fixed internal tubular segment 44, is adapted for sliding telescopic engagement with, and movement therealong by, movable tubular segment 42. Fixed to movable tubular segment 42 is a first strut 48 which preferably extends transversally across the upper portion of movable tubular segment 42 and is preferably secured on either end to movable tubular segment 42, as illustrated in FIG. 17. Preferably extending downwardly from first strut 48 is a second strut 50 which is preferably secured to first strut 48 and preferably also to a sail 34, as illustrated in FIG. 17 and in FIGS. 12, 13, 14, 15 and 16.

Movable sail 34 is preferably planar and positioned fixedly on second strut 50 to remain perpendicular with respect to the axis of vertically oriented outer tube 32. Movable sail 34 is preferably of generally triangular configuration, as best illustrated in FIGS. 16 and 17, with the sides of the triangle curving slightly inwardly. The curved edges 72 of movable sail 34 converge and terminate to form small rectangularly shaped extremities of sail 34 which are designated 76 in FIG. 16.

Movable sail 34 is positioned within generally vertically oriented outer tube 32 so that rectangular extremities 76 are closely adjacent to but do not contact the inner surface of vertically oriented outer tube 32, so long as sail 34 moves vertically up and down within vertically oriented external tube 32. The rectangular shape of extremities 76 with their outwardly facing planar surfaces assures minimal friction and consequent minimal resistance to vertical movement of movable sail 34 in the event one of rectangular extremities 76 contacts the interior surface of vertically oriented tube 32, should sail 34 for some reason move laterally or otherwise and become skew to the vertical axis of tube 32.

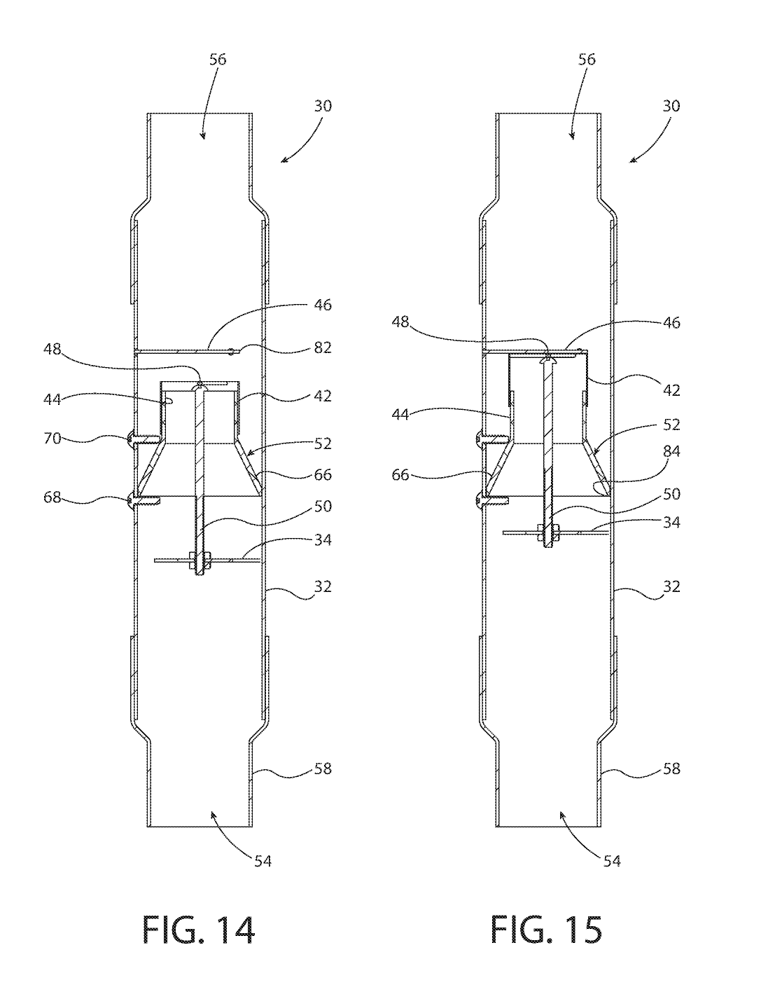

Movable internal tubular segment 42 is telescopically movable, unitarily with sail 34, relative to and along fixed internal tubular segment 44. A lower limit of movement of movable tubular segment 42 is illustrated in FIG. 14, where the first strut portion 48 of movable tubular segment 42 (shown in FIG. 17) rests on the upper circular edge of fixed internal tubular segment 44. This is the condition when no air is flowing through air flow limiter 30 and gravity causes sail 34 together with movable internal tubular segment 42 to drop with first strut 48 coming to rest on the upper circular edge of fixed tubular segment 44.

When air is flowing through air flow limiter 30, as illustrated generally in FIG. 13, the moving air pushes against movable sail 34, moving it upwardly. Movable internal tubular segment 42 moves upwardly unitarily with sail 34 due to the fixed connection of movable tubular segment 42 and movable sail 34 made via first and second struts 48, 50 as illustrated in FIGS. 12, 13, 14, 16, and 17.

If air flow upwardly through air flow limiter 30 reaches an extreme value, above an acceptable level of operation of the system of which air flow limiter 30 is a part, the excessive force (resulting from the high volume air flow contacting sail 34) pushes sail 34 upwardly to the point that upper annular edge 78 of movable internal tubular segment 42 contacts plate 46. In this condition, which is illustrated in FIG. 15, no air can pass between the upper annular edge 78 of movable tubular segment 42 and flow limiting horizontal plate 46, and air flow stops.

Once air flow stops through vertically oriented outer tube 32, gravity pulling downwardly on sail 34, connected movable internal tubular segment 42, and first and second struts 48, 50, causes these parts, which may be connected together and fabricated as a single integral assembly as shown in FIG. 17, to move downwardly, thereby again permitting air flow upwardly through air flow limiter 30 as depicted generally in FIG. 13. Consequently, air flow limiter 30 is self-regulating in that when air flow is too high, the force of air moving or impinging on sail 34 pushes movable internal tubular segment 42 upwardly until upper annular edge 78 of movable tubular segment 42 contacts plate 46 and no air can then escape upwardly between the upper annular edge 78 of movable tubular segment 42 and plate 46. This stops air flow through flow limiter 30 until downward movement of sail 34 together with movable internal tubular segment 42 moves upper annular edge 78 of movable tubular segment 42 away from plate 46, again permitting air to flow through the upper extremity of movable tubular segment 42, with air passing between upper annular edge 78 of movable internal tubular segment 42 and flow limiting horizontal plate 46, and then escaping through upper outlet end 56 of air flow limiter 30.

With the self-regulating characteristic of air flow limiter 30, the assembly consisting of movable internal tubular segment 42, first and second struts 48, 50 and sail 34 may oscillate somewhat about the position at which the desired air flow is supplied, as the blower or vacuum pump driving or drawing air through flow limiter 30 varies in output of cubic feet per minute of air blown or drawn.

Desirably, ends of first strut 48, which is depicted as being horizontally disposed in the drawings, are mounted in movable tubular segment 42 in movable fashion such that first strut 48 can move slightly, rotationally, relative to movable internal segment 42. This is to provide a small amount of “play” in the event movable sail 34 and second strut 50, which is vertically oriented and connected to movable sail 34, become skew with respect to the vertical axis of vertically oriented exterior tube 32. Should this occur, the movable characteristic of first strut 48, being slightly rotatable relative to movable internal tubular segment 42, effectively precludes movable internal tubular segment 42 from binding with respect to fixed internal tubular segment 44 and thereby being restricted from what would otherwise be freely telescoping movement of movable internal tubular segment 42 relative to fixed internal tubular segment 44.

Desirably first strut 48 is rotatable relative to movable internal tubular segment 42, to provide maximum freedom of vertical motion of movable internal tubular segment 42 in the event movable sail 34 becomes skew to the axis of vertically oriented exterior tube 32, with consequent frictional force restricting vertical movement of movable sail 34.

Baffle 52 preferably includes two portions, the upper portion preferably being defined by fixed internal tubular segment 44 and a lower portion preferably being defined by conical portion 66 of baffle 52. A lower edge of baffle 52 is circular and is designated 84 in the drawings. Circular edge 84 fits closely against the annular interior wall of vertically oriented exterior tube 32 so that all air passing upwardly through air flow limiter 30, namely through vertically oriented exterior tube 32, is constrained to flow through the interior of baffle 52. The tight fitting of the circular lower edge of baffle 52 against the interior wall of vertically oriented exterior tube 32 forces all air entering flow limiter 30 from the bottom to flow through the interior of baffle 52, flowing upwardly through lower conical portion 66 of baffle 52. The air then flows further upwardly through the interior of fixed internal tubular segment 44. Thereafter, if movable internal tubular segment 42 is spaced away from flow limiting horizontal plate 46, air flows along the surface of movable internal tubular segment 42, passing the upper annular edge 78 of movable internal tubular segment 42; air then flows around the space between edge 82 of flow limiting horizontal plate 46 and the interior annular wall of vertically oriented exterior tube 32. The air then flows out of air flow limiter 30 via open outlet end 56 formed in end cap 60.

In an alternate approach, baffle 52 may be constructed from two pieces that fit closely together, with the two pieces being in facing contact in the area where they define fixed internal tubular segment 44, but diverging one from another in the area where they define conical portion 66 of baffle 52. In such embodiment, illustrated in FIG. 19, the two portions of baffle 52 are designated “66A” and “66B” where they diverge, with baffle portion 66A serving to channel air flow upwardly through vertically oriented exterior tube 32 into fixed internal tubular segment portion 44 of baffle 52. The space between the lower parts of baffle portions 66A and 66B is filled with a filler material 86 to provide additional assurance that all air entering vertically oriented exterior tube 32 from the bottom flows through fixed internal tubular segment 44 and on through movable internal tubular segment 42, and does not pass around the edge of baffle 52, namely between baffle 52 and the interior surface of vertically oriented exterior tube 32. Filler material 86 provides additional structural rigidity for flow limiter 30.

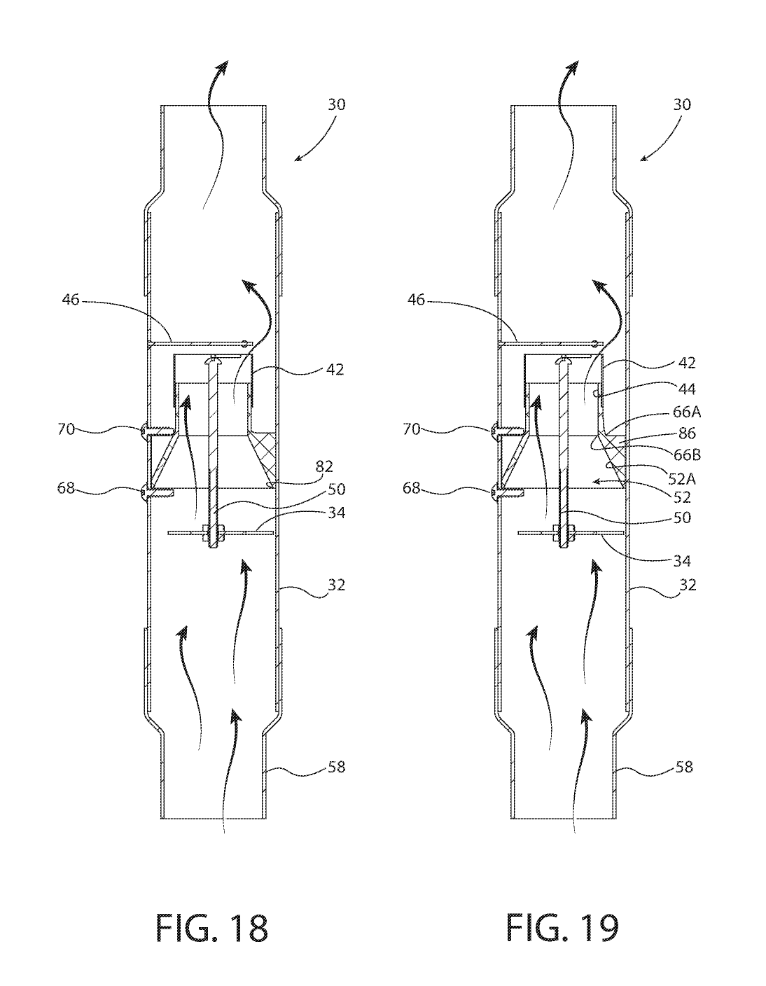

In another alternate approach, baffle 52 is one piece, preferably molded plastic, as illustrated in FIG. 18, where baffle 52 is designated 52B to distinguish it from the baffle construction illustrated in FIG. 19 and the baffle construction illustrated in the other drawing figures. In the baffle construction illustrated in FIG. 18, the one piece construction means that there is no need or space for any filler material. The baffle construction illustrated in FIGS. 10 through 16 is preferred.

The assembly illustrated in FIG. 17 comprising the moveable internal tubular segment 42, first strut 48, second strut 50 and moveable sail 34 may preferably be constructed as a single piece or several pieces as required. The assembly of moveable internal segment 42, first and second struts, 48, 50 and moveable sail 34 is referred to as a “sail assembly.” It is not required that first and second struts 48, 50 be separate pieces; they may preferably be fabricated as a single piece. Additionally, second strut 50, which has been illustrated as a machine screw in FIGS. 16 and 17, need not be a machine screw. Any suitable structure can be used for second strut 50 and it is particularly desirable to fabricate first and second struts 48 and 50 from a single piece of plastic or metal, either by machining or by welding, or by otherwise fastening two pieces together. Similarly with the hex nut, which is unnumbered in FIG. 17 and illustrated there, any other suitable means for attachment of the second strut or a vertical portion of a strut assembly to moveable sail 34 may be used.

Flow limiter 30 contains no springs. Flow limiter 30 preferably contains no sensors to provide feedback to a control device; no sensors are needed because flow limiter 30 is self-regulating. Flow limiter 30 preferably includes a tubular valve, closing against a flat surface, where the tubular valve is defined by movable internal tubular segment 42 closing against flow limiting horizontal plate 46. Movable internal tubular segment 42 is in the form of an open-ended cylinder and is connected to a plate in the form of movable sail 34 to move movable tubular segment 42 against flow limiting horizontal plate 46. Flow limiter 30 uses gravity alone to open the valve defined by the assembly of movable internal tubular segment 42 and movable sail 34 and the connecting structure therebetween.

In the embodiment of the flow limiter illustrated in FIGS. 10 through 15, the movable internal tubular segment 42 is preferably made with a very thin wall, preferably from metal tubing where the wall is preferably less than 1/32 inch in thickness.

Air flow limiter 30 functions equally well with a vacuum pump drawing air through air flow limiter 30 from bottom to top by application of vacuum to outlet end 56, or by air being supplied under positive pressure at inlet end 54 for passage upwardly through air flow limiter 30.

In the course of practice of the invention with any of the granular material or other granular material conveying systems illustrated, different line sizes may be used. While 2½ inch and 1½ inch line sizes respectively are suggested and ordinarily used for the primary resin or other granular material conveying line and for the auxiliary or additive conveying line respectively, these line sizes may be varied. Also, the flow limiters may or may not each be of the same resistance or size, whether located in the primary resin or other granular material conveyance line or in the secondary conveyance line, with the flow limiter being selected for specific resistance to air flow for the particular line size in which it is located. Moreover, it is within the scope of the invention to use different size flow limiters on the same size primary and/or secondary lines, depending on the particular additive or other material being drawn therethrough (in the case of a secondary line) and depending on the nature and characteristic of the granular material being drawn through the primary line.

Most plastic resin or other granular material processes require the basic material be delivered at 50 times the rate of the additives, such as color concentrate. Virgin (or natural) plastic resin pellets or other material granules may have to be loaded at a rate of 1,000 pounds per hour, requiring a 2.5 or 3 inch line size, while granular color or another granular additive may only be required to be delivered at a rate of 20 to 40 pounds per hour. A smaller receiver is desirably used for the color or other additive, namely one that only loads perhaps 5 pounds at a time, while the receiver loading the virgin granular resin or other granular material will be large, loading as much as 50 pounds of resin material or other granular material for each cycle of the process machine. A 2.5 inch line on a 5 pound receiver should not be used. 1 inch line would be the industry standard; use of a 1.5 inch conveyance line for the granular color or other granular additive would be better.

The variable frequency drive motor allows the vacuum pump to operate at different speeds, and therefore at different volume rates, and to pull different vacuum levels depending on preset information about each receiver served, or making adjustment based on feedback of vacuum sensors 214 associated with the receivers. The vacuum sensors 214 and material load sensors may be connected to the variable frequency drive motor 116 of vacuum pump 112 for feedback control of vacuum pump 112. Those connections may be either hardwired or wireless, such as via Bluetooth or the Internet. Such connections have not been shown to enhance the clarity of the drawings.

The flow limiter in the main “air-as-vacuum” flow line allows an oversized vacuum pump to be used without risk of conveying at excessive velocity. The flow limiters restrict air flow to preset levels. This maintains the desired rate of air flow at the upstream inlet to the system, which is critical for proper conveying for a given size convey line.

The systems illustrated in FIGS. 1 through 8 preferably operate completely without human intervention or control. Air limiters 30 and 30-1, as illustrated in the system configurations illustrated in FIGS. 1 through 8, limit the “air flow” (actually vacuum drawn by vacuum pump 12) in a way that systems 100, 100A, 100B, 100C, 100D, 100E, 100F, 100G may operate without human intervention or regulation. Once vacuum pump 112 is started and the various granular material vacuum conveyance lines have been sized appropriately for the amount of granular material to be conveyed therethrough and the level of vacuum to be drawn therethrough by vacuum pump 112 has been selected, the systems operate to deliver granular material to receivers 102A, 102B, 102X without further human intervention.

It is further within the scope of the invention to provide a microprocessor, preferably as a portion of variable frequency drive 114 for vacuum pump 112. The microprocessor, when provided, may desirably be operatively connected to vacuum sensors 214 and, if provided, optional vacuum sensors 215. The microprocessor, which may be referred to as microprocessor 300, receives signals indicating the level of vacuum sensed by vacuum sensors 214 in granular material conveying conduits 107A, 107B, 107X and thereby may regulate speed of vacuum pump 112 by regulating variable frequency drive 114 by controlling the frequency or voltage of the power provided to variable frequency drive 114. This is another way of providing an optimal rate and reliable supply of granular material to receivers 102A, 102B, 102X, 200.

Microprocessor 300 may also use data on material level in a receiver as provided by material level sensor 202, as well as vacuum level data as sensed by vacuum sensors 214 and optional vacuum sensors 215 to control and optimize speed of vacuum pump 112 and to provide data for designers seeking to design even larger capacity, faster, more powerful and more flexible material delivery systems.

When provided, microprocessor 300 may further optionally be connected only to vacuum sensors 216 to receive information regarding level of vacuum throughout a particular granular material conveying system as illustrated in FIGS. 1 through 8, thereby allowing even greater control over the system. However, it is to be understood that microprocessor 300 is an optional element and is not required for the self-controlled, “no-hands-on” operation of the granular material delivery systems illustrated in FIGS. 1 through 8. Those systems deliver granular material from one or more supplies to one or more receivers with the granular material being conveyed under vacuum and the vacuum being controlled by flow limiters 30 and 30-1 in the configurations of the granular material supply systems shown in FIGS. 1 through 8, as well as in variants thereof.

As discussed above and from the foregoing description of the invention, it will be readily apparent to those skilled in the art to which the invention pertains that the principles and particularly the structures disclosed herein and the methods of use thereof can be used for applications other than those specifically mentioned. All such applications of the invention are intended to be covered by the appended claims unless expressly excluded therefrom.

The invention may be embodied in other specific forms without departing from the spirit or essential characteristics of the invention. The disclosed embodiments are therefore to be considered in all respects as illustrative and not restrictive with the scope of the invention being indicated by the appended claims rather than by the foregoing description. All changes which come within the range of equivalency of the claims are therefore intended to be embraced therein.

As used in the claims herein, the term “comprising” means “including” while the term “consisting of” means “including so much and no more” and the term “consisting essentially of” means including the recited elements and those minor accessories and/or adjustments required and known to be used in the art to facilitate the invention as claimed. The scope of the invention is, therefore, indicated by the appended claims rather than by the foregoing description and all changes which come within the range of equivalency of the claims are to be considered to be embraced within the scope of the claims.

The following is claimed:

1. A receiver for use in a vacuum driven pneumatic granular material delivery apparatus having at least one granular material conveyance conduit, for receiving and temporarily holding granular material until needed by a process machine, comprising:
a) a vessel having an input port for receipt of pneumatically conveyed granular material;
b) a sensor for detecting level of granular material in said vessel and opening said input port for receipt of granular material when detected level of granular resin material is low; and
c) a sensor for detecting vacuum level in a granular material conveyance conduit connected to the input port and closing said input port when vacuum level in said granular material conveyance conduit is below that required for successful vacuum loading of the receiver with granular material.

2. A receiver for use in vacuum powered pneumatic granular material delivery apparatus, for receiving and temporarily holding granular material until needed by a process machine, consisting essentially of:
a) a vessel having an input port for receipt of pneumatically conveyed granular material, a first outlet port for discharge of the granular material held in the vessel, and a second outlet port for relief of pneumatic conveying vacuum;
b) a sensor for detecting level of granular material in the vessel and opening the input port for receipt of granular material when detected level of granular material is low; and
c) a sensor for detecting vacuum level in a pneumatic conveyance conduit connected to the input port and closing the input port when vacuum level in the conduit is below that required for successful vacuum loading of the receiver with granular material.

3. A method for operating a vacuum driven pneumatic conveying system delivering granular material to receivers without operator control, comprising:
a) pneumatically delivering granular material under vacuum to any receiver for which a signal indicates granular material level is below a predetermined threshold;
b) sensing vacuum level in respective granular material delivery lines leading to the respective receivers;
c) upon sensed vacuum level in a respective granular material delivery line falling below the level required for the respective receiver to load with granular material, closing the delivery line for the respective receiver.

4. A method for pneumatically vacuum conveying granular material from a supply to plurality of receivers for temporary storage of the granular material therein, comprising:
a) drawing vacuum through a conduit connecting the receivers to the supply by pulling granular material out of the supply through the conduit to the receivers;
b) sensing vacuum level in the conduit proximate an inlet to at least one of the receivers;
c) limiting air flow through the conduit downstream of at least some of the receivers to a preselected maximum; and
d) blocking the inlet of any receiver for which vacuum level is sensed in the conduit proximate an inlet to the receiver whenever vacuum level proximate the inlet falls below that required for conveyance of granular material from the supply to the receiver.

5. The method of claim 4 further comprising opening the blocked inlet of a receiver when vacuum level proximate the inlet reaches the level required for conveyance of granular material from the supply to the receiver.

6. The method of claim 4 further comprising limiting air flow through conduits downstream of each receiver to a preselected maximum.

7. The method of claim 4 further comprising limiting air flow through the conduit at a single position downstream of the receivers to a preselected maximum.

8. The method of claim 4 further comprising sensing vacuum level in the conduit proximate the inlet to each of the receivers.

9. The method of claim 5 further comprising sensing vacuum level in the conduit proximate the inlet to each of the receivers.

10. The method of claim 6 further comprising sensing vacuum level in the conduit proximate the inlet to each of the receivers.

11. The method of claim 7 further comprising sensing vacuum level in the conduit proximate the inlet to each of the receivers.
